(19) United States
(12) Patent Application Publication
(10) Pub. No.: US 2006/0120677 A1
(43) Pub. Date: Jun. 8, 2006

(54) Optical waveguide, method of its production, and its use

(76) Inventors: Jes Broeng, Birkerod (DK); Peter M. w. Skovgaard, Birkerod (DK); Erik Knudsen, Copenhagen N (DK); Jesper Bevensee Jensen, Albertslund (DK); Martin Dybendal Nielsen, Kgs. Lyngby (DK)

Correspondence Address: JACOBSON HOLMAN PLLC, 400 SEVENTH STREET N.W., SUITE 600, WASHINGTON, DC, 20004, US

(21) Appl. No.: 10/515,386

(22) PCT Filed: May 23, 2003
(86) PCT No.: PCT/DK03/00345

§ 371 Date: Jan. 20, 2006

Related U.S. Application Data
(60) Provisional application No. 60/462,710, filed on Apr. 15, 2003.

(30) Foreign Application Priority Data
May 23, 2002 (DK) PA 2002 00787

(51) Int. Cl. G02B 6/032; G02B 6/02

(52) U.S. Cl. 385/125; 385/123

(57) ABSTRACT

An optical waveguide with a longitudinal direction and a cross-section perpendicular thereto for propagating optical radiation at a free-space wavelength λ, the optical waveguide comprising: a core region (103), a cladding region (100, 101, 102) surrounding the core region, and a substantially one-dimensional (1D) periodic structure of structural elements with a period A; wherein said structural elements comprises cross-sectionally extended continuous elements; use of such an optical waveguide in optical amplifier, a tunable optical amplifier, an optical laser, and a tuneable optical laser; a preform for its production; and a method of its production.

### BACKGROUND OF THE INVENTION

The present invention relates to optical waveguides, in particular optical fibres, said optical waveguides comprising periodic structures of structural elements and exhibiting special polarization properties, and the use of such optical waveguides e.g. for polarization maintaining transmission optical fibres (both for short or long distances), in optical amplifiers, or in lasers, in particular for use in high power laser applications with well-defined polarization state at the output.

### THE TECHNICAL FIELD

In the field of optical fibres and waveguides, current polarisation maintaining optical fibres and components have a number of disadvantages such as relatively small modes field diameter and/or limited birefringence. Consequently, there is a need for development of improved polarization maintaining (PM) or polarizing components. These include component-type optical fibres for optical fibre amplifiers and lasers, as well as transmission-type optical fibres e.g. for lithographic systems operating at ultra-violet (UV) wavelength, or e.g. for optical communication transmission systems operating at near-infrared wavelengths (NIR). Especially, for optical fibres and optical communication systems, wherein light is to be guided in a single mode with a relatively large spot-size, there is today a need for development of improved PM optical fibres that exhibit single polarization properties or birefringence on the order of 10⁻⁵ or higher.

There are typically two physical mechanisms that are utilized for the realization of birefringence in optical fibres. These two mechanisms are usually referred to as form birefringence and material birefringence (including stress birefringence) (see for example WO 00/49436 by Russell et al.). Form birefringence is related to the morphology of the fibre cross-section (including arrangement, size, shape, and material of elements or so-called features in the cross-section) Material birefringence, or so-called stress birefringence, is related to mechanical stress in the fibre cross section.

### PRIOR ART DISCLOSURES

WO 00/49436 discloses microstructured optical fibres having at-most-two-fold symmetry that results in form bire-fringence or stress birefringence.

WO 00/60390 by Broeng et al., Steel et al., Optics Letters, Vol. 26, No. 4, pp. 229-231, 2001 and Mogilevtsev et al., J. Opt. A—Pure and Applied Optics, Vol. 3, No. 6, pp. 141-143, 2001 disclose microstructured fibres that exhibit special polarization properties by the use of non-circular cladding elements. By appropriate choice of dimensions, shapes and separations of elements, fibres with a high birefringence can be obtained. Also, fibres that support only a single polarization state can be obtained.

WO 02/12931 by Libori et al. discloses microstructured fibres for dispersion manipulating applications. These fibres obtain special dispersion properties for example by using a microstructured core region. Libori further discloses microstructured fibres wherein the core region comprises microstructured elements that are arranged with a two-fold symmetry; microstructured fibres wherein the core region comprises microstructured elements that are non-circular (such as for example elliptical); and microstructured fibres wherein the shape of the core region is non-circular. Libori teaches that optical fibres exhibiting these latter characteristics can be used for example to obtain birefringent optical fibres.

Ortigosa-Blach et al., Optics Letters, Vol. 25, No. 18, pp. 1325-1327, 2000 disclose a fibre that is highly birefringent through the use of cladding holes with two different sizes. The different sizes create a non-circular shape of the core and a birefringence corresponding to a beat-length of down to 0.4 mm is obtained.

Hansen et al., IEEE Photonics Technology Letters, 13, pp. 588-590, 2001 discloses a highly birefringent microstructured fibre produced by another manner of providing a non-circular core shape wherein similar sized cladding elements are used, but wherein the arrangement of the cladding elements around the core results in non-circularity. The birefringence in the fibres of both Ortigosa-Blanch and Hansen can be explained as form birefringence and they show a high birefringence (more than 10⁻⁴) in the case of relatively small cores (core dimensions comparable to or a few times the free-space optical wavelength λ of light guided through the fibre). For larger cores (core dimensions of several times λ), Hansen demonstrates that the birefringence is significantly decreased.

Suzuki et al., Electronics Letters, Vol. 37, No. 23, pp. 1399-1401, 2001 disclose high birefringence of a polarization maintaining microstructured fibre useful in a polarization division multiplexed system for optical communication. The fibre has a relatively small and substantially elliptical core—with mode field diameters of 3.5 μm and 6.1 μm at λ=1.55 μm (the two dimensions being taking in the (orthogonal) directions corresponding to main axes of the elliptically shaped near field distribution of the fundamental mode).

For high power applications, it is often desired to provide amplifiers and lasers, wherein a relatively large core size and single mode operation is obtained. A particular interesting type of fibre lasers for high power applications are cladding pumped fibre lasers (see for example Webber et al., IEEE J. Quantum Electronics, Vol. 31, No. 2, 1995 or Hideur et al., Optics Communications, 186, pp. 311-317, December 2000). Also optical fibres comprising microstructures have been studied for laser applications (see for example Furusawa et al., Optics Express, Vol. 9, No. 13, 2001 and U.S. Pat. No. 5,907,652 by DiGiovanni et al.). Furusawa discloses a cladding pumped fibre laser comprising a microstructured inner cladding. The inner cladding provides a relatively large core of the laser. It is well known to those skilled in the art that optical fibres may have large core sizes through the use of microstructured inner cladding (see for example WO 99/00685). It is, however, a disadvantage of these fibres of Furusawa that the core is limited in size due to a higher refractive index of the core background material compared to that of the cladding background material. A further disadvantage of the fibre laser of Furusawa is that the fibre does not provide a well-defined polarization mode of lasing.

In WO 02088802, Wadsworth et al. disclose optical fibres comprising a composite material that is substantially homogeneous. The composite material comprises discrete elements that have cross-sectional dimensions that are small compared to an optical wavelength of light guided through the optical fibre. The optical fibres exhibit small, discrete elements placed to form a two-fold symmetry in a cross-section of the optical fibre to provide birefringence.

### DISCLOSURE OF THE INVENTION

### OBJECT OF THE INVENTION

It is an object of the present invention to seek to provide an improved birefringent optical waveguide.

It is another object of the present invention to seek to provide such an improved birefringent optical waveguide which is single moded or few moded.

It is still another object of the present invention to seek to provide such an improved birefringent optical waveguide which exhibits a relatively large core.

It is still another object of the present invention to seek to provide such an improved birefringent optical waveguide which exhibits a strong form birefringence or a strong stress birefringence or a combination-thereof.

It is still another object of the present invention to seek to provide such an improved birefringent optical waveguide in form of a polarizing optical fibre exhibiting a single polarization state.

It is still another object of the present invention to seek to provide such an improved birefringent optical waveguide for handling of high power levels, preferably in the tens of W regime or in the hundreds of W regime or even in the kW regime.

It is still another object of the present invention to seek to provide use of such an improved birefringent optical waveguide, in particular use in amplifier and laser applications such as a high-power laser with a well-defined polarization of the output.

Further objects appear from the description elsewhere.

### SOLUTION ACCORDING TO THE INVENTION

“1D Periodic Structure of Cross-Sectionally Extended Continuous Elements”

In an aspect according to the present invention, these objects are fulfilled by providing an optical waveguide with a longitudinal direction and a cross-section perpendicular thereto for propagating optical radiation at a free-space wavelength λ, the optical waveguide comprising:

a core region,

a cladding region surrounding the core region, and

a substantially one-dimensional (1D) periodic structure of structural elements with a period Λ

wherein said structural elements comprise cross-sectionally extended continuous elements;

whereby a polarization maintaining optical waveguide with “designed” birefringence can be obtained.

In particular, such a waveguide comprising cross-sectionally extended continuous core elements can contain a larger amount of active material, e.g. dopants such as Er, Yb, or Nd, compared with a microstructured core with discrete structural elements whereby an amplifier or a laser comprising a larger amount of active material and exhibiting a higher effect can be obtained.

Generally, the 1D-periodic structure of cross-sectionally extended continuous elements can be arranged in the core region, the cladding region, or both in the core region and cladding region.

In a preferred embodiment, in the cross-section, said substantially one-dimensional (1D) periodic structure of cross-sectionally extended continuous elements is arranged in at least a part of the core region whereby a particularly effective control of the birefringence of the waveguide can be obtained.

In another preferred embodiment, in the cross-section, said substantially one-dimensional (1D) periodic structure of cross-sectionally extended continuous elements is arranged in at least a part of the cladding region whereby a particularly effective control of the birefringence of the waveguide can be obtained, e.g. for a waveguide wherein the core region is optimized for a specific purpose, e.g. for providing single polarisation properties.

In still another preferred embodiment, in the cross-section, a substantially one-dimensional (1D) periodic structure of cross-sectionally extended continuous elements is arranged in at least a part of the core region and another substantially one-dimensional (1D) periodic structure of cross-sectionally extended continuous elements is arranged in at least a part of the cladding region whereby a still further effective control of the birefringence of the waveguide is obtained.

Generally, dimensions of the cross-sectionally extended continuous element are selected in order to provided a desired shape and size of the 1D periodic structure.

In a preferred embodiment, at least one cross-sectionally extended continuous element exhibits a largest dimension larger than or equal to 3λ, preferably in the range including 3λ to 20 λ.

In another preferred embodiment a major part of said cross-sectionally extended continuous elements exhibit a largest dimension larger than or equal to 3λ, preferably in the range including 3λ to 20λ.

In still another preferred embodiment, substantially all of said cross-sectionally extended continuous elements exhibit a largest dimension larger than or equal to 3λ, preferably in the range including 3λ to 20λ.

Generally, dimensions of the cross-sectionally extended continuous element have a lower limit although they are still being selected in order to provide a desired shape and size of the 1D periodic structure.

In a preferred embodiment, at least one cross-sectionally extended continuous element exhibits a smallest dimension less than or equal to 1λ, preferably in the range including 0.3λ to 1.0λ.

In another preferred embodiment, a major part of said cross-sectionally extended continuous elements exhibit a smallest dimension less than or equal to 1λ, preferably in the range including 0.3λ to 1.0λ.

In still another preferred embodiment, substantially all of said cross-sectionally extended continuous elements exhibit a smallest dimension less than or equal to 1λ, preferably in the range including 0.3λ to 1.0λ.

For these preferred embodiments, the cross-sectionally extended continuous elements of various dimensions and number are used to design a desired extent and shape of the core and/or cladding.

In a preferred embodiment, said substantially 1D-periodic structure core elements has a period Λ_{core} smaller than or equal to 3λ, preferably smaller than 2λ, more preferably smaller than 1.5λ, most preferably smaller than 1.3λ, in particular smaller than λ, most particularly smaller than 0.5λ, and larger than 0.3λ which period contributes in controlling birefringence and the possible cut-off of polarisation states.

In another preferred embodiment, said cladding comprises cladding voids or holes that have a substantially circular cross-sectional shape whereby a further control of guiding of the light is obtained by control of the effective index of the cladding.

Generally, the number of cladding voids or holes and their periods are optimized for a particular application.

In a preferred embodiment, said cladding voids are arranged in a substantially two-dimensional periodic manner around said core region, wherein at least 3 periods of cladding voids are surrounding the core region, preferably more than 4 periods, in particular more than 5 periods.

In another preferred embodiment, the cladding voids or holes are arranged with a centre-to-centre distance Λ_{clad} between two of said cladding elements in the range of 3λ to 30λ whereby cores of desired dimensions, e.g. large area cores, can be designed.

In a preferred embodiment, said core region has a cross-sectional dimension of 4λ or more whereby particular large area cores can be designed.

Generally, the structural elements are made of any suitable material for the intended application of the waveguide.

In a preferred embodiment, said structural elements are microstructured whereby the effective refractive index can be controlled.

Further, in a preferred embodiment, said core region and said cladding region comprise silica and/or silica-based materials.

In a preferred embodiment, said cross-sectionally extended elements are of a high-index type of silica material, preferably Si doped with Er, Yb, or Nd, and optionally additional dopants, preferably Al or Ge.

Further, in another preferred embodiment, the material between said cross-sectionally extended elements is undoped silica, or a low-index type of silica material, preferably silica doped with Er, Yb, or Nd, and optionally additional dopants, preferably F or B.

The waveguide may comprise further elements for achieving various purposes.

In a preferred embodiment, said cladding region comprises an outer cladding comprising at least one ring of outer cladding voids or air holes, preferably two nearest outer cladding voids have a spacing, or mutual distance, equal to or less than 0.6 μm whereby the numerical aperture of the waveguide can be controlled, e.g. a NA>0.4 can be obtained.

In a particularly preferred embodiment, the waveguide is in form of an optical fibre.

Preferred embodiments of this waveguide comprise core elements, cladding elements, and further features disclosed for the various aspects of the invention elsewhere in the description, these disclosures are incorporated into this part of the description by reference.

“1D Periodic Core Structure with Cladding Elements”

In another aspect according to the present invention, these objects are fulfilled by providing an optical waveguide with a longitudinal direction and a cross-section perpendicular thereto for propagating optical radiation at a free-space wavelength λ, the optical waveguide comprising:

a core region, said core comprising a substantially one-dimensional (1D) periodic structure of structural core elements with a period Λ_{core}, and

a cladding region surrounding the core region, said cladding region comprising cladding elements arranged with a centre-to-centre distance Λ_{clad}.

In a preferred embodiment, a centre-to-centre distance Λ_{clad} between two of said cladding elements is in the range of 3λ to 30λ.

In another preferred embodiment, the core period Λ_{core} smaller than or equal to 3λ, preferably smaller than 2λ, more preferably smaller than 1.5λ, most preferably smaller than 1.3λ, in particular smaller than λ, most particularly smaller than 0.5λ, and larger than 0.3λ.

Preferred embodiments of this waveguide comprise core elements, cladding elements, and further features disclosed for the various aspects of the invention elsewhere in the description, these disclosures are incorporated into this part of the description by reference.

“Specific 1D Periodic Core Structure with Cladding Elements”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region, said core comprising a substantially one-dimensional (1D) periodic structure of core elements with a period Λ_{core} in the range 0.3λ to 1.0λ, said core elements having a refractive index of n_{1,core}; and being spaced apart by a material of refractive index n_{2,core};

a cladding region surrounding the core region, said cladding region comprising cladding elements arranged in a background material in a periodic structure with a centre-to-centre distance Λ_{clad} larger than 3λ,

wherein the effective refractive index of the core is lower than the refractive index of the background material of the cladding region.

In a preferred embodiment, the difference between n_{1,core} and n_{2,core} is larger than 1·10⁻³, preferably larger than 1·10⁻².

In another preferred embodiment, the ratio Λ_{core}/Λ_{clad} is in the range including 0.02 to 0.5, preferably 0.06 to 0.2.

Preferred embodiments of this waveguide comprise core elements, cladding elements, and further features disclosed for the various aspects of the invention elsewhere in the description, these disclosures are incorporated into this part of the description by reference.

“Two-Fold Rotational Symmetry of 1D Structured Core”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region, said core comprising a substantially one-dimensional (1D) periodic structure of core elements with a period Λ_{core}, said periodic structure of core elements being arranged to exhibit a core shape with a two-fold rotational symmetry about the longitudinal direction, and

a cladding region surrounding the core region.

In a preferred embodiment, said core shape has an extended shape with a smallest dimension y and a largest dimension x, said largest dimension x being larger than 1.2y.

In a preferred embodiment, said core shape has an extended shape with a smallest dimension y and a largest dimension x, said smallest dimension x being smaller than 5y.

In a preferred embodiment, said core shape has a substantially elliptical shape.

Preferred embodiments of this waveguide comprise core elements, cladding elements, and further features disclosed for the various aspects of the invention elsewhere in the description, these disclosures are incorporated into this part of the description by reference.

“1D Structured Core and Stress-Inducing Cladding Elements”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region, said core comprising a substantially one-dimensional (1D) periodic structure of core elements with a period Λ_{core}, and

a cladding region surrounding the core region, said cladding region comprising at least one stress-inducing element.

In a preferred embodiment, said cladding region comprising two stress-inducing elements, said stress-inducing elements being arranged on opposite positions of the core.

In a preferred embodiment, said two stress-inducing elements are arranged orthogonally or parallel with respect to the direction of said 1D periodicity of the core.

Preferred embodiments of this waveguide comprise core elements, cladding elements, and further features disclosed for the various aspects of the invention elsewhere in the description, these disclosures are incorporated into this part of the description by reference.

“1D Structured Cladding”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region,

a cladding region surrounding the core region, said cladding region comprising a substantially one-dimensional (1D) periodic structure of cladding elements with a period Λ_{clad}.

In a preferred embodiment, said core exhibits a shape with two-fold rotation symmetry.

In a preferred embodiment, said cladding comprises cladding elements arranged into sub-groups of at least 2 elements.

In a preferred embodiment, said at least two sub-groups have similar orientation.

Preferred embodiments of this waveguide comprise core elements, cladding elements, and further features disclosed for the various aspects of the invention elsewhere in the description, these disclosures are incorporated into this part of the description by reference.

“1D Structured Cladding”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region,

a cladding region surrounding the core region, said cladding region comprising a periodic structure of subgroups of at least two cladding elements with a period Λ_{clad,sub}.

In a preferred embodiment, said at least two sub-group have similar orientation.

In another preferred embodiment, said periodic structure of subgroups of at least two cladding elements is substantially one-dimensional (1D).

In another preferred embodiment, said period Λ_{clad,sub} is in the range including 0.3λ to 3λ, preferably 0.5λ to 1.0λ.

In another preferred embodiment, said at least two cladding elements have a substantially circular shape or a non-circular shape, preferably an elliptical shape.

Preferred embodiments of this waveguide comprise core elements, cladding elements, and further features disclosed for the various aspects of the invention elsewhere in the description, these disclosures are incorporated into this part of the description by reference.

“Two-Fold Symmetry Core Without 1D Structured Cladding”

In still another aspect according to the present invention, these objects are fulfilled by providing an optical waveguide with a longitudinal direction and a cross-section perpendicular thereto for propagating optical radiation at a free-space wavelength λ, the optical waveguide comprising:

a core region, said core comprising a material having a refractive index n_{core} and exhibiting a shape of two-fold symmetry of rotation, said core providing different guiding of polarized light of different polarization states in the core, and

a cladding region surrounding the core region, said cladding region comprising a periodic structure of cladding elements with a period Λ_{clad}, said cladding elements being arranged in a background material with refractive index n_{clad,back},

wherein said core index n_{core} is selected to be less than said background index n_{clad,back} so that cut-off wavelengths for different polarisation states of the core do not coincide,

whereby the waveguide can be operated in a single polarization state at a wavelength in the range including cutoff wavelength of the guided polarisation states. For single-mode light having two polarization states with cut-off wavelengths λ₁ and λ₂, the waveguide can be operated in a single polarization state at a wavelength in the range including λ₁ to λ₂.

In a preferred embodiment, said waveguide being antiguiding for light of λ<λ₁, single polarized for light of λ₁<λ<λ₂, and birefingent for light of λ₂<λ, λ₁ to λ₂ being cut-off wavelength for polarisation states of the fundamental mode.

“Applications of Waveguides According to the Invention”

In still another aspect according to the present invention, these objects are fulfilled by providing applications of a waveguide according to the invention, including articles and devices incorporating these waveguides.

In preferred embodiments of applications, the waveguide is designed for a wavelength λ in the range from 200 nm to 2.0 μm, preferably in a range of ultra-violet wavelengths, in a range of visible wavelength, or in a range of near-infrared wavelengths.

In another preferred embodiment of applications there is provided an optical amplifier comprising an optical waveguide according to the invention.

In still another preferred embodiment of applications there is provided a tunable optical amplifier comprising an optical waveguide according to the invention, and means for tuning the amplifying spectrum, such tuning means being known in the art.

In still another preferred embodiment of applications there is provided an optical laser comprising an optical waveguide according to the invention.

In still another preferred embodiment of applications there is provided an optical waveguide according to the invention, and means for tuning the lasing wavelength, such tuning means being known in the art.

“Preform with 1D Core and/or 1D Cladding and Production Thereof”

Generally, the various waveguides according to the invention can be produced by any suitable technique, including production of a preform with precursor element specifically arranged in a pattern providing the desired pattern of structural elements of the final waveguide, e.g. an optical fibre obtained by drawing its corresponding preform at suitable conditions known in the art.

In still another aspect according to the present invention, these objects are fulfilled by providing a preform for preparing an optical waveguide according to the invention in its various aspects, the preform being prepared by a method comprising: arranging precursor elements of said structural elements in a substantially 1D periodicity for making up the structural elements in the core, the cladding or both.

In a preferred embodiment, said precursor structural elements comprise precursor elements for cross-sectionally extended continuous elements.

In a preferred embodiment, said precursor elements for cross-sectionally extended continuous elements comprise substantially plate-formed elements.

Preferred embodiments of this preform comprise precursor elements for core elements, cladding elements, and further features disclosed for the various aspects of the invention elsewhere in the description, these disclosures being incorporated into this part of the description by reference.

In still another aspect according to the present invention, these objects are fulfilled by providing a method of producing an optical waveguide according to the invention in its various aspects, the method comprising: preparing a preform according to the invention, and drawing said preform into a waveguide, preferably an optical fibre.

### BRIEF DESCRIPTION OF THE DRAWINGS

In the following, by way of not limiting examples, the invention is further disclosed with detailed description of preferred embodiments. Reference is made to the drawings in which

FIG. 1 shows a cross sectional sketch of an embodiment of an optical waveguide according to the present invention in form of an optical fibre. The core comprises a region of substantially 1D periodic structure (or layered structure). A periodic direction is defined as orthogonal to the layers of the substantially 1D periodic structure;

FIG. 2a shows a close-up schematic look of a core region and an inner part of the cladding region of a preferred embodiment of a fibre according to the present invention. In a cross-section, the optical fibre comprises core elements that are elongated in one direction x to a dimension several times larger than the free-space optical wavelength λ of light guided through the optical fibre. In an orthogonal direction y the cladding elements have a dimension comparable to or smaller than λ;

FIG. 2b shows a schematic example of a preferred embodiment of an optical fibre according to the present invention, where the high-index layers in a part of the core region has been made using stacked layers of high-index type of silica rods;

FIG. 3a shows a cross sectional sketch of an embodiment of a preform or parts thereof according to the present invention. The preform comprises row or layers of tubes and/or rods having alternating refractive index. The rows or layers form a substantially 1D periodic structure. The preform further comprises an overcladding tube;

FIG. 3b shows another cross sectional sketch of an embodiment of a preform or parts thereof according to the present invention. The preform also comprises a substantially 1D periodic structure. No overcladding tube is employed for this preform;

FIG. 3c shows another cross sectional sketch of an embodiment of a preform or parts thereof according to the present invention. The preform comprises layers of plates that differ in material and/or refractive index profile;

FIG. 3d shows another cross sectional sketch of an embodiment of a preform or parts thereof according to the present invention. The preform comprises layers of at least two types of plates that differ in material and/or refractive index profile;

FIG. 4 shows another cross sectional sketch of an embodiment of a preform or parts thereof according to the present invention. In the centre, the preform comprises an element having a substantially 1D periodic structure. The element may be drawn from a preform as shown schematically shown in FIG. 3a or 3b;

FIGS. 5a and 5b show simulations of the effective refractive mode indices of core region and cladding region as a function of normalized wavelength λ/Λ_{clad} in the range 0-0.4, and 0.1-0.2, respectively;

FIG. 6 shows a close-up view of the mode indices at the long-wavelength cut-off edge around λ/Λ_{clad}=0.15 of the simulated fibre which results are shown in FIGS. 5a and 5b;

FIG. 7 shows a close-up view of the mode indices at the short wavelength cut-off at around λ/Λ_{clad}=0.035 of the simulated fibre which results are shown in FIG. 5a and 5b;

FIG. 8 shows an example of simulated effective refractive mode indices of a fibre similar to that of FIGS. 5a and 5b, but with a cladding background refractive index of 1.458;

FIG. 9 illustrates a similar same type of mode indices as for the simulated effective refractive indices of a fibre shown in FIGS. 5 and 7 with the same design parameters as those in FIG. 7, except that Λ_{core} is equal to 0.09 Λ_{clad}.

FIG. 10 shows a cross sectional sketch of another embodiment of an optical waveguide according to the present invention in form of an optical fibre. The fibre has a substantially 1D periodic structure in the core, and the core has a substantially elliptical shape;

FIG. 11 shows a cross sectional sketch of another embodiment of an optical waveguide according to the present invention in form of an optical fibre. The fibre has a substantially 1D periodic structure in the core, and the core has a substantially elliptical shape. The fibre is further characterized by a microstructured cladding;

FIGS. 12a and 12b show cross sectional sketches of other embodiments of an optical waveguide according to the present invention in form of an optical fibre. Each fibre has a substantially 1D periodic structure in the core, and the core has a substantially elliptical shape. The fibre is further characterized by two stress-inducing cladding elements aligned orthogonal to the periodic direction (FIG. 12a) and aligned parallel to the periodic direction (FIG. 12b);

FIG. 13 shows a cross sectional sketch of another embodiment of an optical waveguide according to the present invention in form of an optical fibre. The optical fibre has a substantially 1D periodic structure in the core, and the core has a substantially elliptical shape. The fibre is further characterized by a microstructured cladding and two stress-inducing cladding elements;

FIG. 14a shows a cross sectional sketch of another embodiment of an optical waveguide according to the present invention in form of an optical fibre. The fibre has a substantially 1D periodic structure in the cladding. FIG. 14b shows a simulation of a single-polarization state that is guided by the fibre. The fibre only supports this polarization state;

FIG. 14c shows a cross sectional sketch of another embodiment of an optical waveguide according to the present invention in form of an optical fibre. The fibre has a substantially 1D periodic structure in the cladding. In a cross-section, the optical fibre comprises cladding elements that are elongated in one direction to a dimension several times larger than an optical wavelength of light guided through the optical fibre;

FIG. 15 shows another cross sectional sketch of an embodiment of a preform or parts thereof according to the present invention. In the centre, the preform comprises core-forming elements. Surrounding the core-forming elements, the preform comprises at least two types of elements that are arranged in row or layers to form a substantially 1D periodic structure;

FIG. 16 shows simulations of the effective refractive indices of core region and cladding region as a function of normalized wavelength λ/Λ_{clad} in the range 0-2.5. The figure shows that the fibre may be operated as a high birefringence fibre for λ/Λ_{clad} larger than around 0.9, and as a single polarization (or polarizing fibre) for λ/Λ_{clad} less than around 0.9;

FIG. 17a shows a cross sectional sketch of another embodiment of an optical waveguide according to the present invention in form of an optical fibre. The optical fibre comprises a region having a substantially 1D periodic structure, and an air-cladding to form a high NA. The optical fibre is preferably used in cladding-pumped schemes for high power applications (average power levels above 1 W);

FIG. 17b shows a cross sectional sketch of another embodiment of an optical waveguide according to the present invention in form of an optical fibre. The optical fibre comprises a region having a substantially 1D periodic structure, and an air-cladding to form a high NA. The fibre further comprises further birefringence-enhancing elements. The optical fibre is preferably used in cladding-pumped schemes for high power applications (average power levels above 1 W);

FIG. 18a shows a cross sectional sketch of another embodiment of an optical waveguide according to the present invention in form of an optical fibre. The optical fibre comprises a core region or parts thereof with a non-circular shape. The fibre further comprises low-index cladding elements placed in a cladding background material. The fibre is further characterized in the core region or at least a part thereof comprises material with a lower refractive index than the cladding background material;

FIG. 18b shows a similar type of fibre as illustrated in FIG. 18a, whereas the fibre further comprises an air-clad region;

FIG. 19 shows schematically the effective refractive indices of the type of fibres illustrated in FIGS. 18a and 18b. The fibres are able to act as anti-guiding fibre for a wavelength, λ, shorter than λ₁, to act as polarizing fibres for λ in the range from around λ₁ to λ₂, and to act as birefringent (or polarization maintaining) fibres for λ larger than around λ₂;

FIG. 20 shows an optical microscope picture of an optical fibre according to a preferred embodiment of the present invention;

FIG. 21 shows a cross sectional sketch of another embodiment of an optical waveguide according to the present invention in form of an optical fibre. The optical fibre comprises a core region and a cladding region. The cladding region comprises cladding elements that are placed in sub-groups of two or more elements;

FIG. 22 shows a cross-section of a structure that is simulated in order to analyse the fibre in FIG. 21; and

FIG. 23 shows simulations of the effective refractive indices of core region and cladding region as a function of normalized wavelength λ/Λ_{clad} in the range 0.3-1.4.

### DETAILED DESCRIPTION

“Optical Waveguide with 1D Periodic Structure”

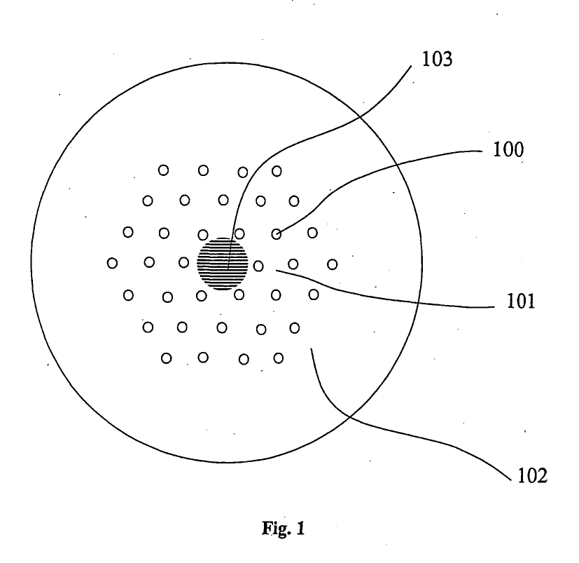

FIG. 1 shows a cross sectional sketch of an embodiment of an optical waveguide according to the present invention in form of an optical fibre. The fibre comprises elongated cladding elements 100 in the cladding that run along the length of the fibre. The cladding elements are placed in a cladding background material 101 in a periodic structure as further discussed below. The cladding elements surround a core region 103 comprising a structure of core elements as further discussed below. In a cross-section of the fibre, the core region comprises at least one region that exhibits a substantially 1D periodicity of layered core elements. The fibre may comprise a solid outer cladding 102.

The fibre has a centre-to-centre separation of the cladding holes Λ_{clad} that is significantly larger than a typical period of the substantially 1D periodic core region Λ_{core}. Preferably, Λ_{core} is comparable or smaller than a free-space wavelength λ of light guided in the fibre, typically smaller than 3λ, and Λ_{clad} is significantly larger than λ. Typically, Λ_{clad}, is larger than 3 times λ in order to realise a relatively large core size.

In a simplistic view, the short period of the structure in the core region (comparable to or shorter than λ) provides an artificial anisotropic material in the core. The function of the short-period, 1D structuring of the core region is such that a fundamental mode in the core will not be able to resolve accurately the individual rows or layers and the overall fundamental mode will distribute itself relatively uniformly over the core region. The two polarization states of the fundamental mode will, however, orientate themselves according to the orientation of the substantially 1D periodic core structure. In this manner, a core material with an artificial anisotropy may be created and the fibre is, thereby, capable of exhibiting birefringence.

Preferably, the fibre is designed such that the effective refractive indices of the two polarization modes are comparable to the refractive index of the cladding background material. In this case, single mode or few mode fibres with even extremely large core sizes can be obtained using the (large) cladding microstructure to confine light in the core.

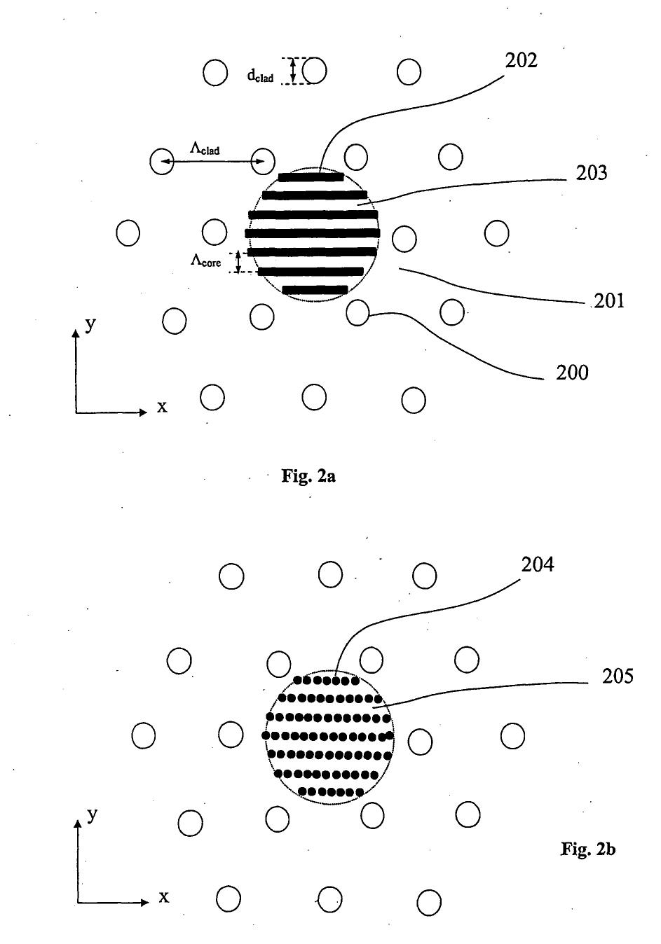

FIG. 2a shows an example of a close-up schematic look of a core region and an inner part of the cladding region of a preferred embodiment of a fibre according to the present invention. The cladding elements 200 are shown in the cladding background material 201, similar to that shown in FIG. 1. The core region comprises core elements of at least two types of material—one being a high-index type 202 and the other being a low-index type 203. In a preferred embodiment, the optical fibre is made from silica-based glasses. The cladding elements are voids (such as air holes) and the cladding background material is silica, or silica including one or more co-dopants. The core region preferably comprises silica doped with one or more index-raising co-dopants (high-index type core material). Pure silica or silica doped with one or more co-dopants preferably provide a low-index type of material in the core region.

In a preferred embodiment, the optical fibre, in a cross-section, comprises core elements that are elongated in one direction x to a dimension several times larger than the free-space optical wavelength λ of light guided through the optical fibre, such as more than 3λ. This type of elements shall be labelled laterally or cross-sectional extended continuous elements. In an orthogonal direction y the cladding elements have a dimension comparable to or smaller than λ. Hence, a transverse cross-sectional area of a core element is large enough to affect light guided in the fibre. For example, the area is large enough to affect the effective index of the core region. The small dimension of the core element in the direction y provides a periodicity, Λ_{core}, of the substantially 1D periodic structure that is comparable to λ. This short-scale periodicity creates the desired artificial anisotropy that provides birefringence of the optical fibre.

Preferred embodiments of the present invention relates to optical fibres for amplifiers and lasers; materials and dopants that may be used for such optical fibres are known in the art, see e.g. “Rare-earth-doped fiber lasers and amplifiers”, 2. Ed, M. J. F. Digonnet, Marcel Dekker, the content of which is incorporated herein by reference.

It is preferred that the core region comprises at least one core element 202 or 203 that has a cross-sectional dimension being in the range of 3 to 20 times λ. In preferred embodiments, a majority or all of the core elements have a cross-sectional dimension being in the range from 3λ to 20λ. In comparison with core elements of cross-sectional dimensions comparable or smaller than 1, that are not in contact with each other, the elongated shape of the core elements in FIGS. 1 and 2a provides in total a larger cross-sectional area of the core elements. In preferred embodiments, the core elements 202 comprise an active material, such as silica doped with Er, Yb, Nd, and/or other active dopants. Particularly in the case of optical fibres for amplifiers and lasers, it is desired to provide as much active material in the core region as possible, in order to increase amplification, output power etc. It is, therefore, an advantage to provide a core region comprising core elements with a cross-sectional elongated shape of dimensions several times λ, such that the total amount of active material in the optical fibre is increased.

FIG. 2b shows a schematic example of a preferred embodiment of an optical fibre according to the present invention, where the high-index layers in a part of the core region has been made using stacked layers of high-index type of silica rods 205. The low-index type of silica 205 in the core region is defined using rods of a similar refractive index as the background material of the cladding, for example F300 silica glass supplied by the company Hereaus. In other preferred embodiments, however, the low-index type of silica in the core region can have a different (e.g. lower) refractive index than the cladding background material. In a preferred embodiment, the optical fibre, in a cross-section, comprises cladding elements that are substantially similar in dimension in directions x and y.

“Method of Production”

Embodiments of optical fibre according to the present invention may be obtained using methods known in the art that have been adapted to provide embodiments of substantially 1D periodic, cross-sectional, index patterns according to the invention. These methods include the methods described by DiGiovanni et al. in U.S. Pat. No. 5,802,236, Broderick et al. in WO 02/14946, or any of the afore-mentioned references on microstructured fibres. Particularly, in a preferred embodiment it is advantageous to prefabricate the element of the core region by stacking high- and low-index elements in a substantially layered manner inside an overcladding tube. This overcladding tube is then drawn to a (solid) core rod with the inner structure being substantially 1D periodic in at least a part of the cross-section. The resulting core rod is hereafter used in a preform for a preferred embodiment of a microstructured fibre according to the invention in a manner that is well known for producing microstructured fibres. For example, the core rod is surrounded by a number of close-packed capillary tubes of similar outer dimension as the core rod. The ensemble of capillary tubes and the core rod can optionally be placed in an overcladding tube prior to fibre drawing.

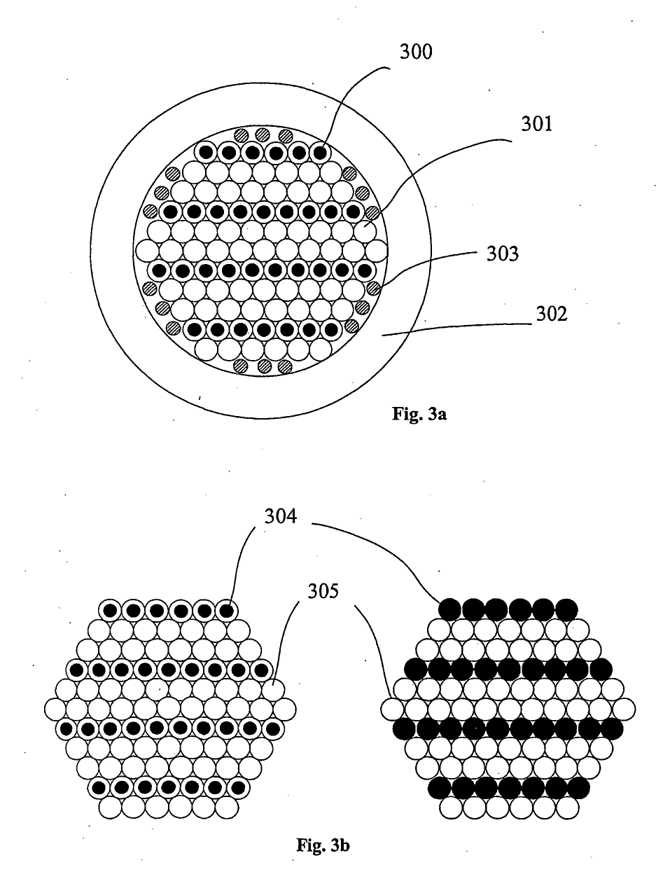

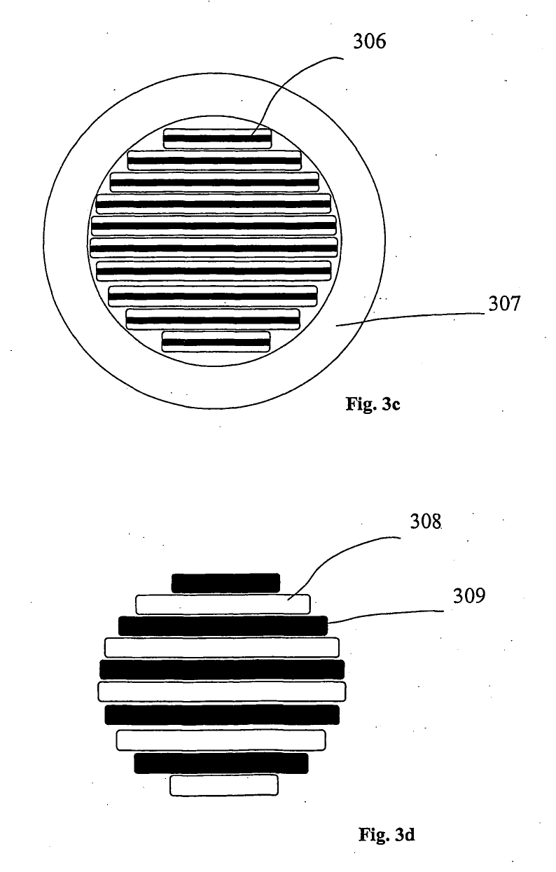

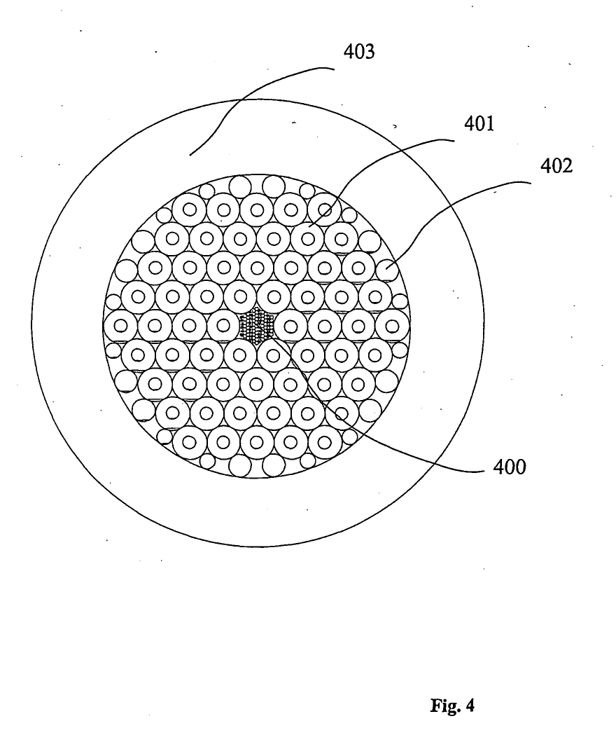

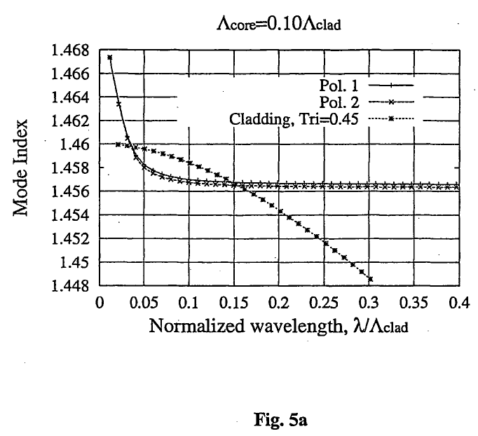

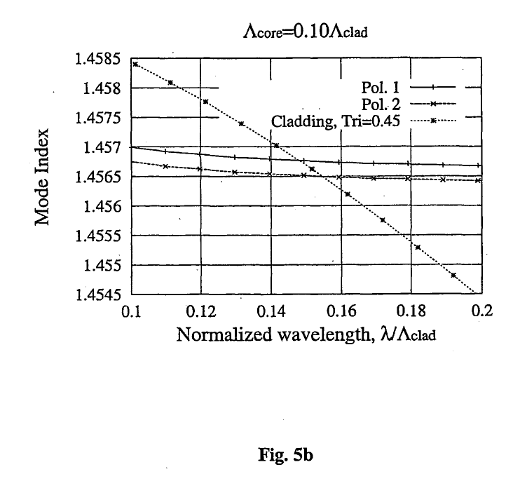

Preferred embodiments of the present invention includes preforms or parts thereof for producing an optical fibre with a substantially 1D periodic structure in at least part of a cross-section of the optical fibre. FIGS. 3a, 3b, 3c, 3d and 4 illustrate examples of preferred embodiments of preforms or parts thereof for producing optical fibres according to various preferred embodiments of the present invention.

In a cross-section, the preform in FIG. 3a comprises a first type of elements 300 and a second type of elements 301, said first and second type of elements differing in material, refractive index, and/or refractive index profile. The first and second types of elements are elongated elements and they have a length that is typically in the range from a few centimetres to several meters. Typically, the first and second types of elements have a circular cross-sectional shape, although a range of other shapes can be used. The first and second types of elements have diameters that are preferably in the range from a few tenths of a millimetre to several millimetres. The first and second type of elements are arranged in rows or layers to provide a substantially 1D periodic structure. The first and/or the second type of elements can have any suitable refractive index profile, e.g. a uniform or a complex refractive index profile. Typically, the layered arrangement of first and second type of elements is placed within an overcladding tube 302. Optionally buffer elements 303 of uniform or different size are used to fill out gaps between the layered stack and the overcladding tube. Buffer elements are typically used to stabilize the preform, and they do not or only insignificantly affect the waveguiding properties of the final optical fibre. Alternatively, the preform may be produced without the use of buffer elements and overcladding tube, as illustrated in FIG. 3b. The elements 304 and 305 may be of any suitable material and refractive index profile, including uniform and complex refractive index profile. The shape of the substantially 1D periodic structure is controlled by the arrangement of the first and second type of elements, e.g. the number of layers, the width of each layer, etc. For example, the substantially 1D periodic structure in FIG. 3a is arranged to have a substantially elliptical shape by replacing first and/or second type of elements with buffer elements. Further, the number of layers in the preform (and in the final optical fibre) is flexibly adjusted through the choice of dimensions and number of first and second type of elements, and the optional buffer elements and overcladding tube. Preferably, the buffer elements are homogeneous and of a material similar to the overcladding tube.

In a cross-section, the preform in FIG. 3c comprises a stack of a first type of elements 306. The elements 306 are plates that have a longitudinal direction and a cross-section perpendicular thereto. In the cross-section, the plates have a non-uniform refractive index profile. The plates are arranged in layers to provide a substantially 1D periodic structure. The period of the structure may be defined in a cross-sectional direction orthogonal to the plates. In the cross-section, the plates have a smallest and a longest dimension, the two dimensions differing by a factor of at least 3, preferably be a factor of more than 5. The plates have a length that is typically in the range from a few centimetres to several meters. The cross-sectional dimensions are typically in the range of a few tenths of a millimetre to several millimetres. The plates can have any suitable refractive index profile, e.g. a uniform or a complex refractive index profile. Typically, the plates are placed within an overcladding tube 307. Optionally buffer elements (not shown) may be used—as described above.

FIG. 3d shows another example of a preform according to a preferred embodiment of the present invention, where plates of two types of material are used. The plates are stacked in a layered manner to provide a substantially 1D periodic structure.

The plates may be produce in various manners. For example, the plates made be produced by extrusion, or may be produced by using sol-gel techniques (glass parts produced using sol-gel may, for example, be supplied from the company Simax; further information on sol-gel techniques may, for example, be found in U.S. Pat. No. 4,680,045, where the shape of the cylinder may be adapted to the desired shape of the plates, or EP 1172339 where the shape of a vessel comprising a sol-gel may be adapted to have a plate-like shape and elongated elements are removed or non-present); the plates may be produced using rods of optical glass (for example solid glass rods by Hereas) that have been chemically etched, mechanically polished or otherwise post-processed to make slices of a rod. For example, slices from two different types of glass rods may be used to provide plates that differ in material and/or refractive index profile. Alternatively, the slices may be made from standard optical preform. Optionally, the slices may include active and/or passive material from the preform core. In this manner, materials and dopants that are known in the art of optical fibres may be employed. Alternatively, the plates themselves may be produced using stacks of slices.

Typically, a preform as shown in FIGS. 3a, 3b, 3c, and 3d is drawn into at least one element of smaller diameter (referred to as preform cane). Typically, this is done using a fibre drawing tower with an operating temperature of around 1900° C. for silica-based materials. For other materials of the preform, other temperatures may be required. Alternatively, the preform can be stretched in a lathe. This lathe may, for example, be a conventional lathe for handling of overcladding tubes for conventional optical fibre preforms. Optionally, a pressure control can be applied to the interior of the overcladding tube during the drawing or stretching process. For example a less-than-atmospheric pressure can be applied to the interior in order to collapse voids within the preform. In a preferred embodiment, the preform in FIGS. 3a or 3b is drawn into a solid preform cane with a diameter of around 1 to 5 mm. This preform cane 400 is preferably used as element in another preform—as schematically illustrated in FIG. 4. Apart from the preform cane 400, the preform in FIG. 4 is a conventional preform for producing microstructured fibre, comprising capillary tubes 401, optional buffer elements 402, and an overcladding tube 403. The preform in FIG. 4 may be drawn into microstructured optical fibre, as known to a person skilled in the art, see e.g. afore-mentioned references by DiGiovanni et al.

“Simulation of Specific Optical Fibre Examples”

To exemplify the above-described teachings of the present invention, consider the fibre of FIG. 2a, with a cladding background material having a refractive index, n_{clad}, of 1.460 (such as for example silica co-doped with Ge) and air holes of diameter, d, equal to 0.45Λ_{clad}. The core has high-index material with refractive index, n_{core,high}, of 1.470 (such as for example silica doped with Ge) and low-index material with refractive index, n_{core,low}, of 1.443 (such as for example silica doped with F). The filling fraction f of high-index material compared to low-index material in the substantially 1D periodic part of the core is 0.50 (hence the width of a high- and low-index layer being substantially identical). Alternatively, the core may be made active, such as for amplifier or laser applications, where for example the high-index and/or the low-index core material is silica doped with one or more rare earths (such as for example Er, Yb, and/or Nd) and optionally at least one (such as for example Ge, Al, and/or F). The fibre is further characterized by Λ_{core} around 0.10Λ_{clad}.

FIGS. 5a and 5b show simulations of the effective refractive indices of the core region and the cladding region as a function of normalized wavelength, λ/Λ_{clad}. This normalization has been chosen as the fibre properties of microstructured fibres can generally be scaled to a desired operational wavelength, by scaling the dimensions of the fibre. The effective refractive index of the core region has been calculated for the two orthogonal polarization states of the core region (labelled “Pol. 1” and “Pol. 2”), where an approximation of assuming an infinitely 1D periodic core structure was used. The effective refractive index of the cladding structure (labelled “Cladding, Tri=0.45”) has been calculated using an approximation of a fully symmetric, hexagonal structure (such a structure does not exhibit birefringence, hence the two orthogonal polarization states of the cladding structure has similar effective refractive index at all wavelengths). Details of the method of calculating effective refractive indices as used here may for example be found in Broeng et al., “Optical Fiber Technology”, Vol. 5, pp. 305-330, 1999, the content of which is incorporated herein by reference. Looking first at the two extremes of short and long wavelengths, we see from the figure that the effective refractive of the core region approaches 1.470 in the short wavelength limit. In this limit, the light is capable of fully resolving the 1D-periodic structure, and the light in both polarization states of the fundamental mode will tend to concentrate in the high-index core material (having refractive index of 1.470). Going towards longer wavelengths, however, the effective refractive index of the two polarization states will split up. From FIG. 5a, it is seen that the strongest variation in refractive index of the two core polarization states is for λ up to around 0.15 times Λ_{clad}, hence for λ up to around 1.5 times Λ_{core}. At longer wavelengths, the light in the core has a limited ability to resolve the core structure; hence the effective refractive index remains approximately the same for each of the polarization states; however, the splitting of the two polarization states remains. The behaviour of the effective refractive index of the cladding region is described well in the prior art, see for example aforementioned Broeng et al. reference. In the long wavelength regime, the two polarization states are seen (FIG. 5a) to have a refractive index around 1.456. A simple calculation of the geometric refractive index, n_{core,geo}, of the core region, defined as n_{core,geo}=f n_{core,high}+(1-f)n_{core,low}, results in n_{core,geo}=1.4565. It has turned out that, in general, microstructured fibres with a microstructured core design having n_{core,geo} approximately equal to the refractive index of the cladding background material, n_{clad,back}, (such as index differences of less than about ±0.5%) can be single mode or few mode for even very large core sizes (such as core dimensions of more than several times λ). Despite the large core sizes and the fact that the nearfield distributions of both polarization states of the fundamental mode are nearly circular, the fibre in FIG. 2a may still exhibit a birefringence as shown in FIG. 5a. The fibre may for example be designed to operate at λ or around 1 μm, with Λ_{clad} of around 5 μm (λ/Λ_{clad}=0.2), Λ_{core}=0.5 μm, and cladding holes of size, d_{clad}, 2.25 μm. In this example, the fibre has a (large) bire-fringence on the order of 2*10⁻⁴. The core diameter of this fibre is around 2Λ_{clad}−d_{clad}=7.75 μm. As shall be demonstrated at a later stage, even larger core sizes can be obtained.

A further important property of the fibre in FIG. 5a is that the two polarization states have a lower effective refractive index than the cladding region over a certain spectral range, here of about λ/Λ_{clad}=0.035 to 0.15. Within this spectral range, the fibre is anti-guiding hence the fibre is capable of providing spectral filtering effects. In preferred embodiments, such filtering effects may advantageously be used for fibre amplifiers or fibre lasers where a part of the emission spectrum is filtered away, in order to enhance amplification or lasing in other parts of the emission spectrum. For example, a short or a long wavelength part of the spectrum may be filtered out to reduce amplified spontaneous emission, to control lasing wavelength, etc.

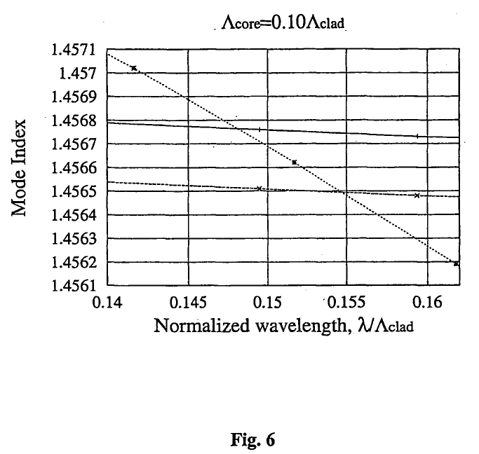

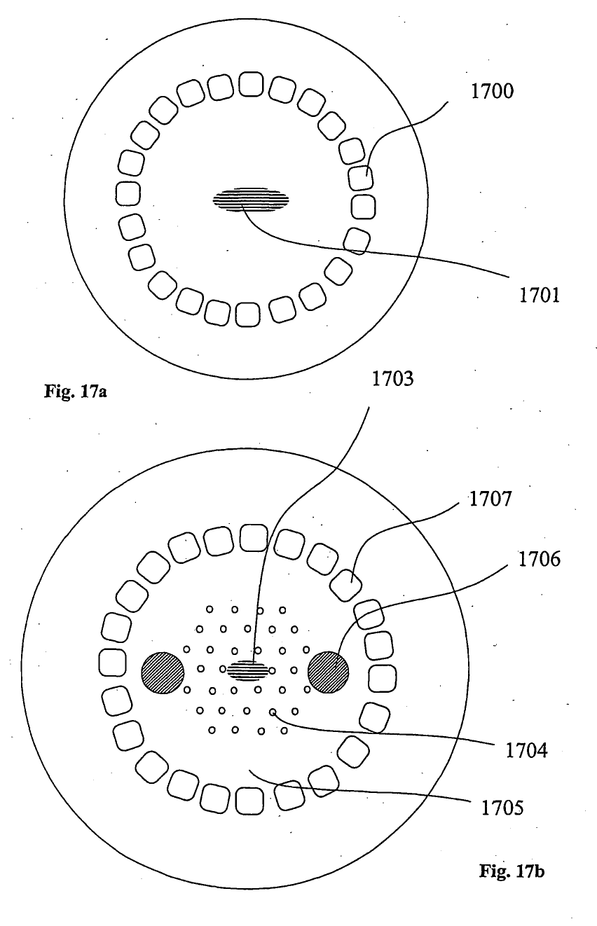

FIG. 6 shows a close-up view of the long-wavelength cutoff edge around λ/Λ_{clad}=0.15 of the simulated fibre which results are shown in FIGS. 5a and 5b. The fibre is seen to have two different cut-off values of the two polarization states. Hence the fibre may be operated in a spectral range where polarization state 1 “Pol. 1” is guided and polarizations state 2 “Pol. 2” is anti-guided. This is the case for λ/Λ_{clad} of around 0.148 to 0.155. Hence, for this spectral range the fibre can be operated as a single polarization optical waveguide. As an example, for operation at λ=1.55 μm, Λ_{clad}=10.3 μm (λ/Λ_{clad}=0.15) and d_{clad}/Λ_{clad}=0.45 (d_{clad}=4.6 μm), the core diameter, d_{core}, is approximately 16 μm (d_{core}=2Λ_{clad}−d_{clad}), and the fibre may be operated in a single polarization state from approximately λ=1.53 μm to 1.60 μm. As another example, for operation at λ around 1.06 μm, Λ_{clad}=7.1 μm (λ/Λ_{clad}=0.15) and d_{clad}/Λ_{clad}=0.45 (d_{clad}=3.2 μm), the core diameter, d_{core}, is approximately 11 μm (d_{core}=2Λ_{clad}−d_{clad}), and the fibre may be operated in a single polarization state from approximately λ=1.05 μm to 1.10 μm. For amplifier and laser applications, the optical fibre may in this manner be used to provide well-defined, single polarization output for a relatively large core size. Such large core sizes make the optical fibre attractive for high-power amplifier and laser applications. The design of the microstructured, substantially 1D periodic core may preferably be combined with high numerical aperture (NA) cladding pumped fibre designs, such as described in WO03019257 claiming priority from Danish patent applications PA 2001 00897, PA 2001 01815, PA 2002 00158, PA 2002 00285 and U.S. provisional patent applications 60/336,136 and 60/353,236 that are all incorporated herein by reference. Preferred embodiments of the present invention relating to high NA optical fibres are further described in connection with FIGS. 17 to 20.

It further turns out that the cut-off of the two polarization states may be changed by for example changing the effective refractive index of the cladding. This may for example be done by incorporating various materials, such as liquids or polymers in the cladding voids. In this manner, it is for example possible to realize tuneable fibre amplifiers and lasers, as well as single polarization or polarization maintaining amplifiers and lasers with tuneable signal wavelength.

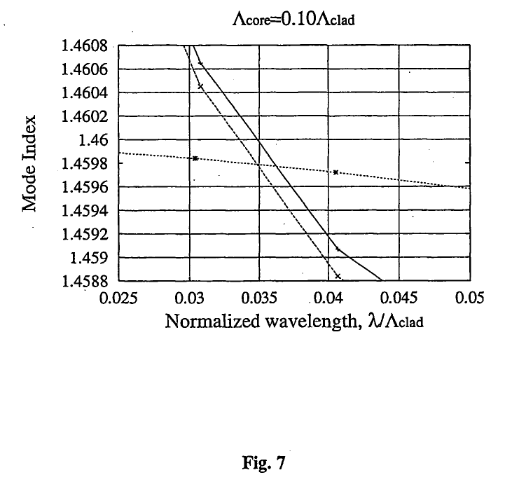

FIG. 7 shows a close-up of the short wavelength cut-off at around λ/Λ_{clad}=0.035 of the simulated fibre which results are shown in FIG. 3a and 3b. At this wavelength, the two polarization modes still have a splitting of their effective refractive index, and the afore-described polarization selection may be utilized to provide single polarization optical waveguides and/or for filtering effects as previously discussed. Due to the shorter normalized wavelength, the dimensions of the fibre become extremely large. As an example, the dimensions of the previously discussed fibre operating at around 1 μm become 0.2/0.035 times larger, hence resulting in a core diameter of around 44 μm.

Fibres according to preferred embodiments of the present invention have a large number of design parameter to tailor the properties for a specific application. These design parameters include the cladding and/or core element size, shape, arrangement, material(s), refractive index profile; and the cladding and/or core background material and refractive index profile. Optionally, further features or elements may be comprises in the fibre. Even further design freedom may for example be obtained through longitudinal variations along the fibres—for example tapering. This design freedom may, for example, be used for mode-filtering, such as stripping off of higher-order modes or an undesired polarization state.

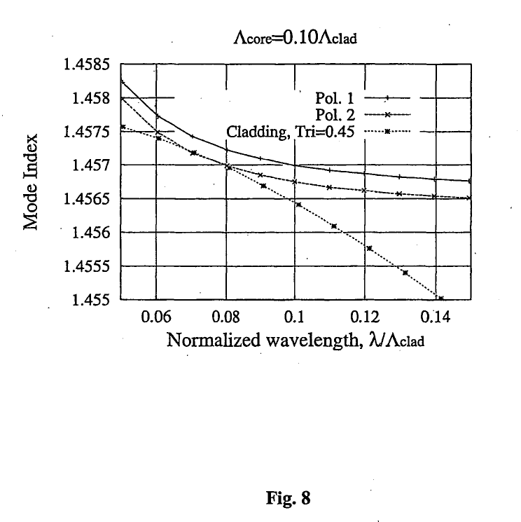

As an illustration of changing a single design parameter for the afore-discussed fibre, FIG. 8 shows an example of a simulated fibre similar to that of FIGS. 5a and 5b, but with a cladding background refractive index of 1.458. The fibre is found to have no cut-off for polarization mode 1, whereas polarization mode 2 is close to cut-off at normalized wavelengths of around λ/Λ_{clad}=0.07.

By a further adjustment of one of the design parameters compared to the fibres in FIGS. 5a, 5b, and 7, it is possible to provide a very broad spectral range, where a fibre supports only a single polarization state.

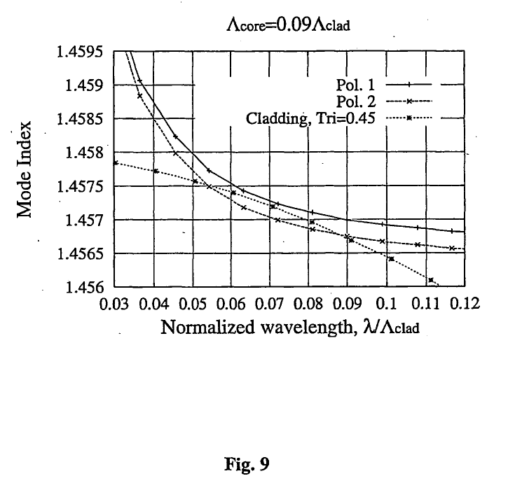

FIG. 9 illustrates the same type of mode indices as the simulated fibre of FIGS. 5a and 5b and 7 for a fibre with the same design parameters as that in FIG. 5a and 5b and 7, except that Λ_{core} is equal to 0.09 Λ_{clad}. For this fibre, it is found that polarization state 1 is the only supported polarization state from λ/Λ_{clad} of about 0.05 to about 0.09. As an example, the fibre may be designed to operate at λ=1.55 μm for λ/Λ_{clad}=0.07. This yields Λ_{clad} of 22.1 μm, Λ_{core}=2.0 μm and a core diameter of around 35 μm, while the fibre supports a single polarization state from approximately λ=1.1 μm to 2.0 μm. As another example, the fibre may be designed to operate at λ=1.06 μm for λ/Λ_{clad}=0.09. This yields Λ_{clad} of 11.8 μm, Λ_{core}=1.1 μm and a core diameter of around 18 μm, while the fibre supports a single polarization state from approximately λ=0.6 μm to 1.1 μm.

“Stress-Induced Birefringence”

Stress birefringence may also be utilized as an improvement to optical fibres according to various preferred embodiments of the present invention. In a preferred embodiment, the substantially 1D-periodic structure provides stress birefringence. In particular, it is preferred that the substantially 1D periodic structure comprises materials with different thermal expansion coefficients.

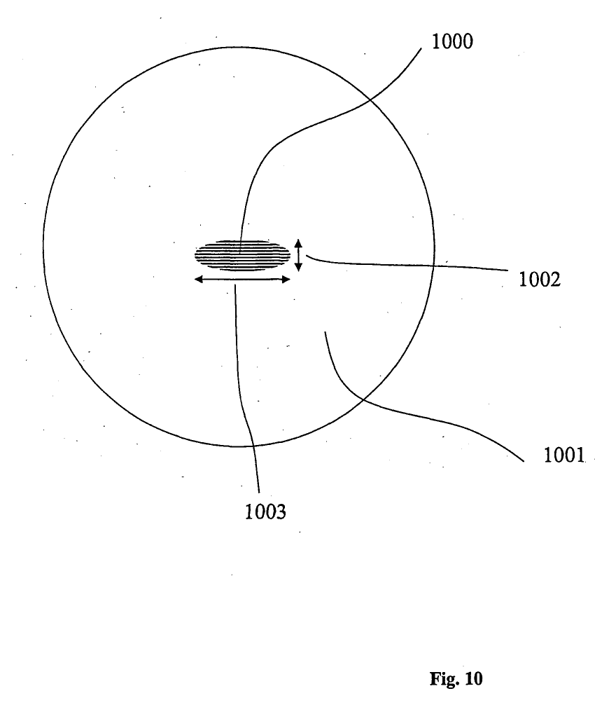

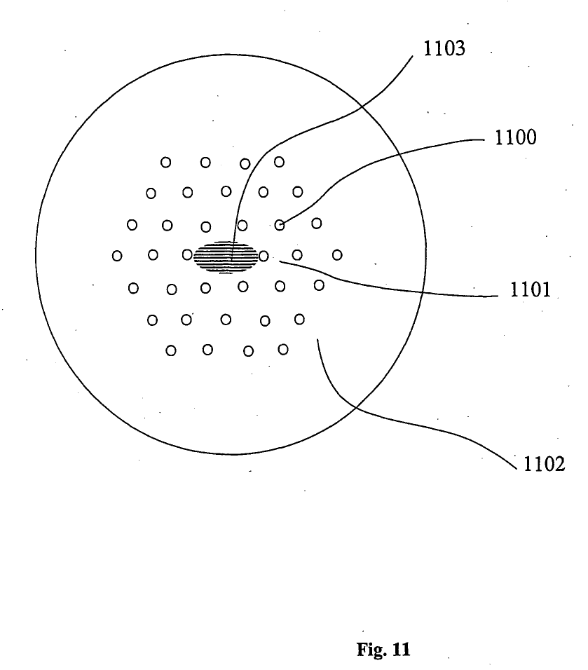

As another example of an optical fibre according to a preferred embodiment of the present invention, FIG. 10 illustrates schematically an optical fibre comprising a core 1000 and a cladding region 1001; the optical fibre is characterized by a substantially 1D periodic structure in at least a part of the core region, where the substantially 1D periodic structure has a substantially non-circular shape, such as for example an elliptical shape. Preferably, the shape is substantially two-fold symmetric having a largest dimension, x, 1003, and a smallest dimension, y, 1002. Preferably, x is larger than y by a factor of at least 1.2, such as larger than 1.5, such as larger than 2.0. Further, it is preferred that x is in the range of 1.2 times y to 5.0 times y.

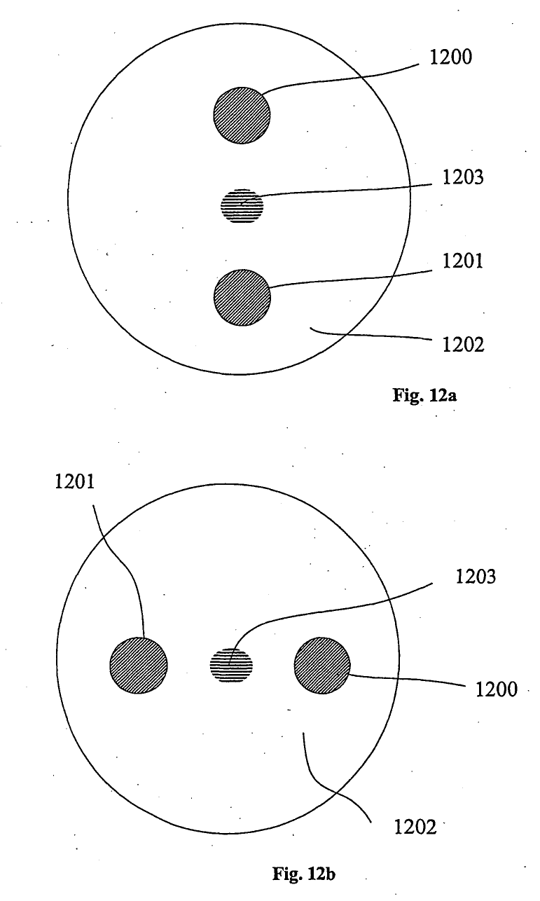

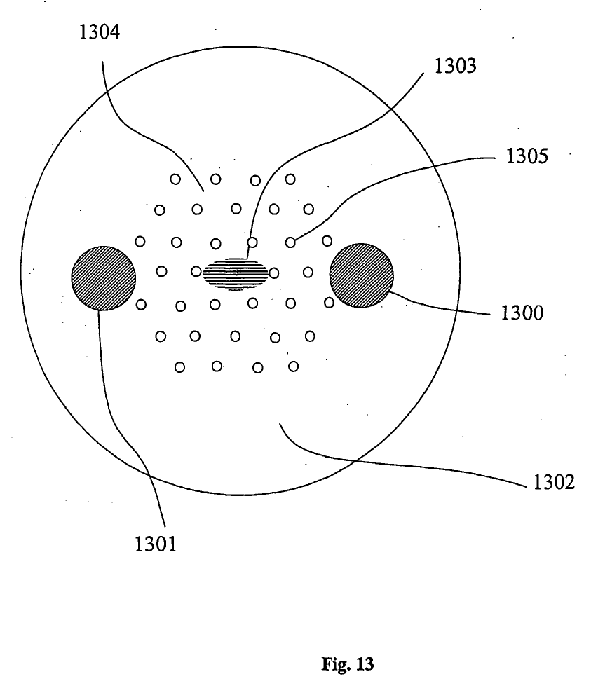

In FIG. 10, a solid, uniform cladding was illustrated; however, other cladding designs may be preferred. As an example, the core 1103 may be surrounded by a cladding that comprises cladding elements 1100 (typically air-holes) placed in a cladding background material 1101 (typically silica), and a solid overcladding 1102 (typically silica)—see FIG. 11. As another example, the core 1203 may be surrounded by a cladding that comprises stress-inducing cladding elements 1200 and 1201 (typically solid material as known from the technology of so-called PANDA fibres; stress-inducing elements may be supplied by the company Highwave). The stress-inducing cladding elements are placed in a cladding background material 1202 (typically silica)—see FIGS. 12a and 12b. The stress-inducing cladding elements are preferably placed on opposite sides of the core to provide stress across the core. In preferred embodiments, the number of stress-inducing elements is two. In further preferred embodiments, the stress-inducing cladding elements are placed orthogonal to a first orientation of the substantially 1D periodic structure in the core (see FIG. 10a) to enhance birefringence. In other words, a fictive line connecting centres of the two stress-inducing cladding elements is orthogonal to the rows or layers of high- and low-index materials that compose the substantially 1D periodic structure. In other preferred embodiments, the stress-inducing elements are place ‘in-line’ with a first orientation of the substantially 1D periodic structure in the core (see FIG. 10b) to enhance birefringence. Naturally, also various combinations of the above-described preferred embodiments are within the scope of the present invention. As an example, consider the schematic illustration of the fibre cross-section in FIG. 13. In FIG. 13, the optical fibre comprises a core region and a cladding region; the core region comprises a substantially 1D periodic structure 1303 having a substantially elliptical shape, and the cladding region comprises a number of cladding elements 1305 (typically air-holes) that are placed in a cladding background material 1304, the cladding further comprises two stress-inducing cladding elements 1300 and 1301, the cladding has a background material 1304 (typically silica) and an outer, solid overcladding part 1302.

“Substantially 1D Periodic Structure in Cladding Region”

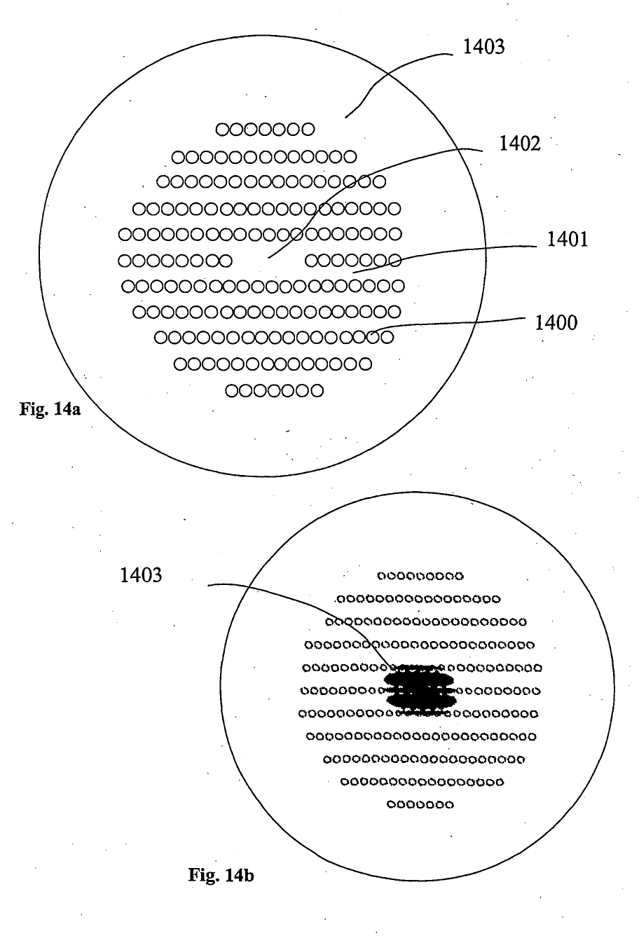

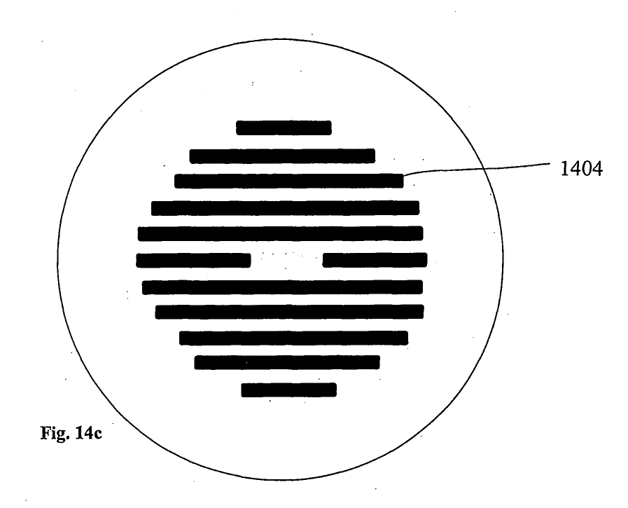

It has further turned out that the advantages of using a substantially 1D periodic structure may also be employed for the cladding of an optical fibre. FIG. 14a illustrates an example of preferred embodiment of the present invention relating to an optical fibre where the cladding comprises a substantially 1D periodic cladding structure. In the cross-section, the optical fibre in FIG. 14a comprises a core region 1402 where light may be guided (a simulated mode field distribution 1403 is illustrated in FIG. 14b). The cladding is characterized by cladding elements 1400, or 1404 as shown in FIG. 14c, that are placed in a substantially 1D periodic arrangement within a cladding background material 1401. The fibre may further comprise a solid overcladding 1403. The cladding elements may be identical or various types of cladding elements may be present. The cladding elements may be solid (for example silica or doped silica) or hollow (for example air-holes). The cladding elements may be circular or non-circular. The cladding elements may have cross-sectional dimension that are comparable to λ (FIG. 14a), or they may have one cross-sectional dimension being several times larger than λ (FIG. 14c). Elements that have a cross-sectional dimension of several times 1 have been discussed in connection with FIGS. 1, 2a, 3c, and 3d, and similar technical advantages and manners of production may be employed.

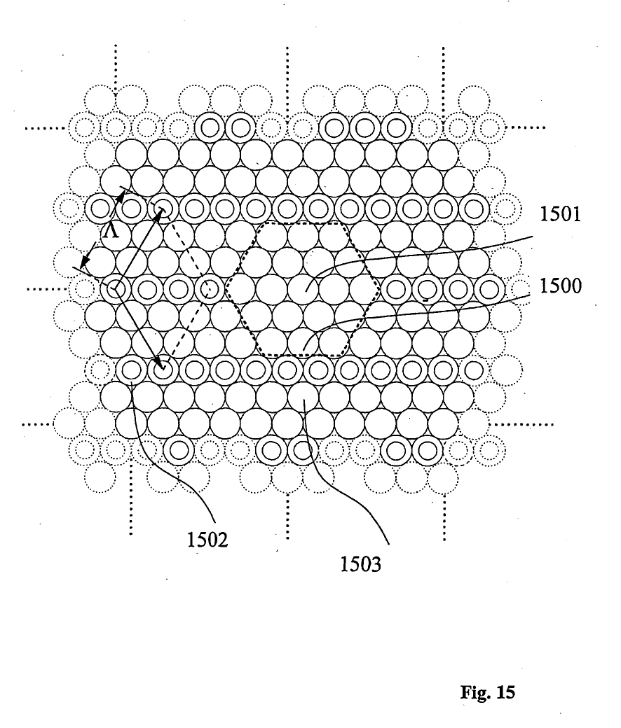

An optical fibre with a substantially 1D periodic cladding structure may, for example, be fabricated using a preform as schematically illustrated in FIG. 15. In FIG. 15, a cross-section of the inner parts of a preform is illustrated. The preform comprises a core region 1500 with a number of core elements 1501 (a single or more core elements may be used). The preform further comprises a cladding characterized by a first 1502 and second 1503 type of cladding elements that are placed in rows or layers to provide a substantially 1D periodic cladding structure. The first and second type of cladding elements may be chosen from various types of tubes and rods of various materials and refractive index profiles. Typically, the first type of cladding elements 1502 are of a low-index type (such as hollow capillary tubes or solid silica rods comprising a partly or fully down-doped cross-sectional region), and the second type of cladding elements 1503 are of a high-index type (such as solid pure silica rods or solid silica rods comprising a partly or fully up-doped cross-sectional region). The outer parts of the preform may comprise buffer elements and an overcladding tube—as for example illustrated in FIG. 4. The preform in FIG. 15 may be used to produce microstructured optical fibres by drawing the preform in one or more steps as known to a person skilled in the art of producing microstructured optical fibres.

As compared to a preform for a microstructured optical fibre with a close-packed arrangement of low-index cladding elements placed around a core region, the specific preform in FIG. 15 may be defined to have a pitch Λ of three times the diameter of a single first or second cladding element. The period of the substantially 1D periodic structure in direction orthogonal to the layers, Λ_{clad}, is \sqrt{3}Λ/2.

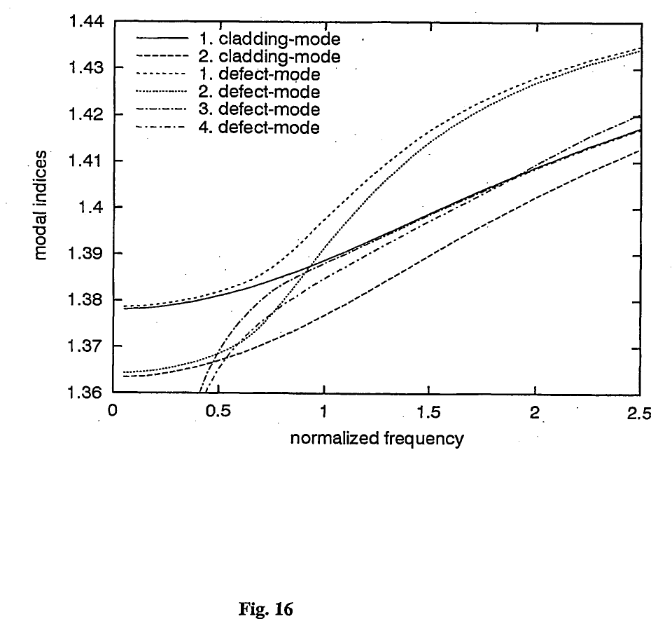

To exemplify, a fibre produced using a preform as schematically shown in FIG. 15 shall be analysed. The fibre is made from pure silica and air (the first cladding elements 1502 being hollow, pure silica tubes, the second cladding elements 1503 and the core element 1501 being solid, pure silica rods). The fibre has air-holes substantially arranged in rows or layers. The air-holes are characterized by a diameter d. In this example, an optical fibre with a d-value of around 0.12Λ shall be analysed, where Λ is the parameter shown in FIG. 15, but scaled to the dimensions of optical fibre. FIG. 16 shows a simulation of the modal indices (or mode-indices) for modes mainly localized to the core region of the fibre (labelled “1. to 4. defect-mode”) and the lowest order modes of the cladding (labelled “1. and 2. cladding-mode”). The modal indices are simulated as a function of normalized frequency, defined as Λ/λ. The two cladding modes are not two modes in conventional understanding. Rather, the two cladding-modes are the two polarization states of the fundamental mode supported by the cladding (these two states are anti-guided). The 1. and 2. defect-modes of the core are the two polarization states of the fundamental mode supported by the core (the core modes are usually guided modes). The vertical distance in FIG. 16 between the two polarization states of the fundamental mode of the core may be interpreted as the birefringence of the optical fibre. The 3. and 4. defect-modes are higher-order modes of the core. These higher-order modes may not be guided by the fibre (at a given normalized frequency, the higher-order modes are anti-guided in the case of their modal index being lower than the modal index of a cladding mode). For this set of parameters, an interesting property is observed for Λ/λ of around 0.9; here it is found that the mode-index curve of one of the two polarization states of the fundamental mode (2. defect-mode) is crossing the mode-index curves of one of the higher-order modes (3. defect-mode) and one of the cladding modes (1. cladding mode). Around this normalized frequency, small perturbation along the fibre axis may cause coupling of light between these modes—hence causing increased loss of one of the polarization states of the fundamental core mode compared to the other.

Generally, the above-described mechanism may be used to strip-off one polarization state and provide a polarizing fibre. Alternatively, the mechanism may be utilized in providing a single-polarization laser, where the optical fibre acts in a cavity and comprises a gain material. In that case, the difference in loss of the two core polarization states will cause lasing in the polarization state of lowest loss (a well-known mechanisms in the field of lasers and referred to as mode-competition). The cavity may, for example, be made using external mirrors and/or internal mirrors from Bragg gratings in the optical fibre. The gain material may, for example, be silica doped with Er, Yb and/or Nd. It is important to notice that the above-described mechanism of mode-competition may be obtained from optical fibres with substantially 1D periodic structure in the core region, in the cladding region, or for a combination of the two. Hence, preferred embodiments of the present invention covers single polarization lasers made using optical fibres according to the various preferred embodiments of the present invention.

While a solid, uniform core region was used for the preform and optical fibre example discussed above, various alternatives exists for the core region and are within the scope of the various aspects of present invention. For example, in combination with the substantially 1D periodic cladding structure, the core may comprise a substantially 1D periodic structure as previously discussed in details.

In relation to active optical fibres, specifically optical fibre amplifiers and fibre lasers, it is relevant to provide optical pump power using cladding pumped schemes. The present invention includes preferred embodiments, where the 1D periodic structure in the core and/or the cladding is employed in combination with high numerical aperture (NA) air-clad designs. FIG. 17a shows an example of such an optical fibre, where the core 1701 comprises a substantially 1D periodic structure, and the cladding comprises air-holes 1701 to provide a high NA. The core has preferably a non-circular shape, such as for example an elliptic shape. FIG. 17b illustrates another preferred embodiment, where an optical fibre is provided with a substantially 1D periodic core 1703, a number of low-index cladding elements 1704 that are placed in a cladding background material 1705. The fibre may further comprise two or more stress-inducing cladding elements 1706. The fibre may further comprise an air-clad region 1707 that provides a high NA of more than 0.40 or preferably more than 0.50 to provide a high pump-light intensity of the clad-pumped fibre while preserving moderate brightness. The brightness may be defined as the NA multiplied by an inner diameter of the air-clad. In preferred embodiments, the inner diameter is in the range from 50 μm to 400 μm, such as from 150 μm to 250 μm, and the NA is in the range from 0.45 to 0.65.

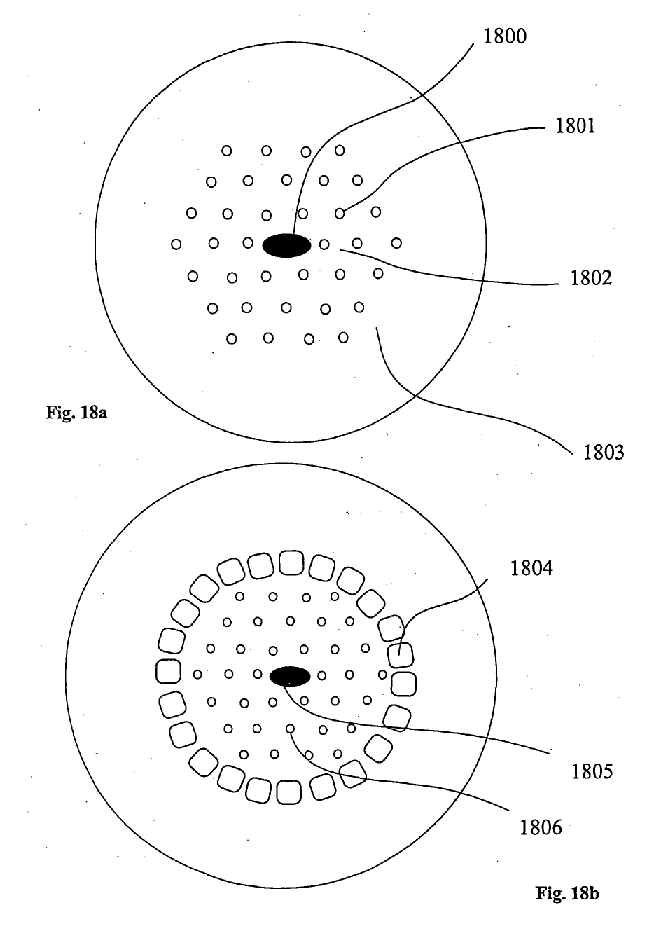

It has further turned out that the special polarization properties may be obtained for an optical fibre with a cross-sectional design as schematically shown in FIG. 18a and FIG. 18b. The preferred embodiments in FIGS. 18a and 18b comprises a core 1800, 1805 and a cladding; the fibres are characterized in that the core comprises a part with a non-circular shape, preferably an elliptical shape, and further comprises material of refractive index n_{core}, and the cladding comprises low-index cladding elements 1801, 1806, preferably air-holes, that are placed in a background cladding material of refractive index n_{clad,back}; and n_{core} being lower than n_{clad,back}. Preferably, the optical fibre comprises an air-clad region 1804 that provides a high NA of more than 0.40, by having thin bridging regions between air-holes 1700 in the air-clad of dimension, b, of around or less than 0.6 μm. Preferably, the dimension b is around 0.5 μm or smaller.

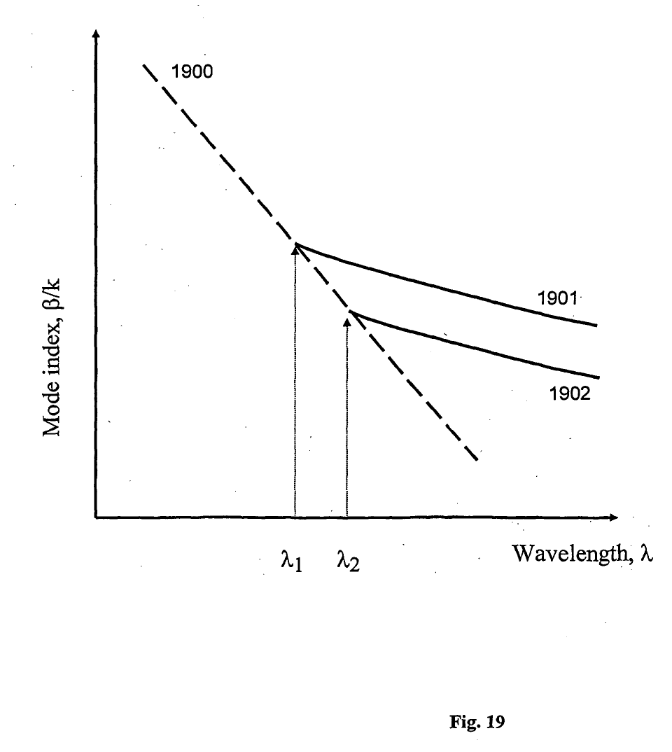

The operation of the fibre in FIGS. 18a and 18b is schematically illustrated in FIG. 19. Here, the mode index is shown for the cladding 1900, and for the two polarization states 1901, 1902 of the core. The low-index cladding elements cause a decreasing cladding mode-index for increasing wavelength. The elliptical shape of the core causes a splitting of the two polarization states of the core, and the relation n_{core}<n_{clad,back} causes a cut-off of each polarization states for short wavelengths. The cut-off wavelengths of the two polarization states are labelled “λ₁” and “λ₂”. As seen from the illustration, λ₁ and λ₂ are not coinciding, and the fibre may be operated in a single polarization state in the wavelength range from around λ₁ to λ₂. Hence, the optical fibre design provides mechanisms resembling the mechanisms discussed for the optical fibres comprising substantially 1D periodic structures. Similarly, the optical fiber may guide both polarization states with a (large) birefringence for wavelengths larger than λ₂. Therefore, in a preferred embodiment, an optical fibre with a design as discussed for FIGS. 18a and 18b is employed as an amplifier or a laser with one dominant polarization state. In preferred embodiments, the optical fibres of FIGS. 18a and 18b are improved by using further design features such as for example stress-inducing elements or other elements/features described in connection with the various examples of the present invention.

“Step-Wise Production”

Embodiments of the optical fibres with air-cladding may be produced in a step-wise process. In the process, capillary tubes of approximately 2 mm in outer diameter, and inner diameter of approximately 1 mm and 1.5 mm were prepared and arranged in a periodic structure. The large inner diameter capillary tubes may be used to form an eventual air-clad, and the smaller inner diameter capillary tubes may be used to form an eventual inner cladding. A single or more central capillary tubes may be replaced by one or more solid canes to form the eventual core. Preferably, the central cane(s) comprises a substantial 1D periodic structure and is produced as previously described in connection with FIGS. 3a, 3b, and 4. The stacked structure may be placed in an overcladding tube to provide a preform and the preform may be drawn to a preform cane with a diameter of around 7 mm using a conventional drawing tower operating at a temperature of around 1900° C. The preform cane may afterwards be drawn into an optical fibre using the same conventional drawing tower.

Embodiments of preforms and parts thereof may be prepared by controlled heat treatment, optionally under pressure and/or vacuum of the capillary tubes and the interstitial voids between the tubes. A skilled person would know how to calibrate the parameters of the preparation, e.g. the temperature, pressure, vacuum, with respect to the glass of the capillaries applied, e.g. its thickness, viscosity, softness, etc., see e.g. the afore-mentioned references by DiGiovanni et al. or Broderick et al., the contents of which are incorporated herein by reference.

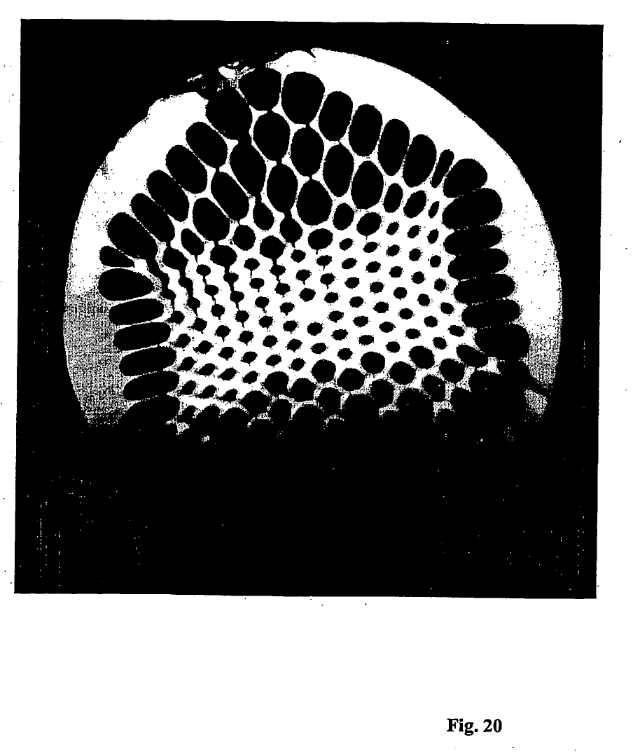

FIG. 20 shows an optical microscope picture of the cross-section of an optical fibre according to a preferred embodiment. The fibre comprises a core and an inner cladding with low-index cladding elements (here air-holes) placed in a solid cladding background material (here pure silica), and an air-clad region formed from air-holes of relatively large size. The interface between the inner cladding and the air-clad may not be clearly defined. The air-clad may have various shapes. In FIG. 20, the interface is not clearly defined, but it is apparent that the inner cladding may have a substantially rectangular shape. Outer preferred shapes include circular, elliptical and D-shapes. The core region comprises a material with refractive index n_{core}<n_{clad,back}. The core has a substantially elliptical shape. The elliptical shape is, in this example, obtained by the shape and position of the air-holes in the inner cladding. The air-holes have a slightly elliptical shape. The position of the air-holes in the inner cladding and their slightly elliptical shape was obtain during a production method as outlined above. This production method included the steps of providing a preform, drawing the preform into a preform cane, and drawing the preform cane into fibre. The preform comprised an overcladding tube, wherein there was stacked a number of precursor elements, here capillary tubes. The core of the preform was a single rod of Yb-doped silica comprising Al, and F to increase solubility of the Yb and decrease the refractive index of the rod, respectively. The preform was drawn using a conventional drawing into a preform cane. The preform cane was thereafter drawn into fibre, where the holes in the preform cane were pressurized. The various holes in the preform and/or cane are preferably pressurized separately to improve structure control during drawing. During drawing of the preform cane into fibre, the larger holes of the air-clad expand more than the smaller holes of the inner cladding. This expansion causes a distortion of the fibre structure, such that an elliptical shape of the core region was obtained.

The optical fibre in FIG. 20 has core dimensions of around 8 μm to 11 μm for the largest and shortest dimension, respectively. The remainder of dimensions may largely be deduced from the core dimensions; for example the outer diameter of the fibre is around 180 μm. Other dimensions are also within the scope of the invention.

“Optical Fibre with Sub-Groups of Cladding Elements”

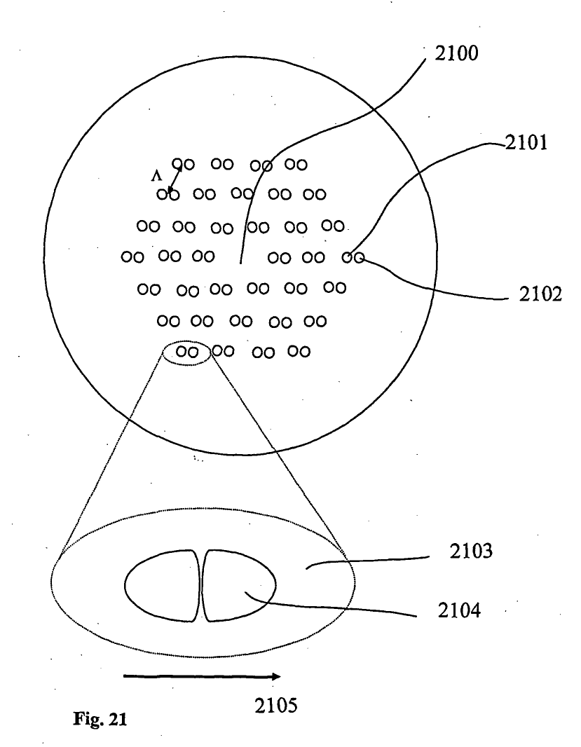

FIG. 21 shows a cross sectional sketch of another embodiment of an optical waveguide according to the present invention in form of an optical fibre. The optical fibre comprises a core region 2100 and a cladding region. The cladding region comprises cladding elements 2101, 2102 that are placed in sub-groups 2103 of two or more elements. In preferred embodiments, the sub-groups have a centre-to-centre spacing Λ in the range of around 0.3 to 2.0 times a free-space wavelength λ of light guided through the optical fibre. In a preferred embodiment, the sub-groups are placed in a substantial periodic manner. In a preferred embodiment the individual cladding elements may be placed such that the sub-groups obtain a substantially similar orientation. In this manner, the orientation of the sub-groups forms a substantially 1D periodic structure according to the invention. The individual cladding elements within a sub-group may have various shapes, such as for example circular 2101, 2102 and/or non-circular 2104, the latter shown in a close-up view. The placement or orientation (the orientation indicated by the arrow 2105) of the sub-groups may also be utilized to provide a non-circular shape of the core region; for example a substantially elliptical shape as shown for the core region 2100. Also, the core region may comprise sub-groups of two or more core elements, where the sub-groups have an orientation that form a substantially 1D periodic structure. The substantially similar orientation of the sub-groups provides birefringence to the optical fibre. The use of sub-groups of cladding and/or elements may advantageously be combined with the various other aspects and preferred embodiments of the present invention.

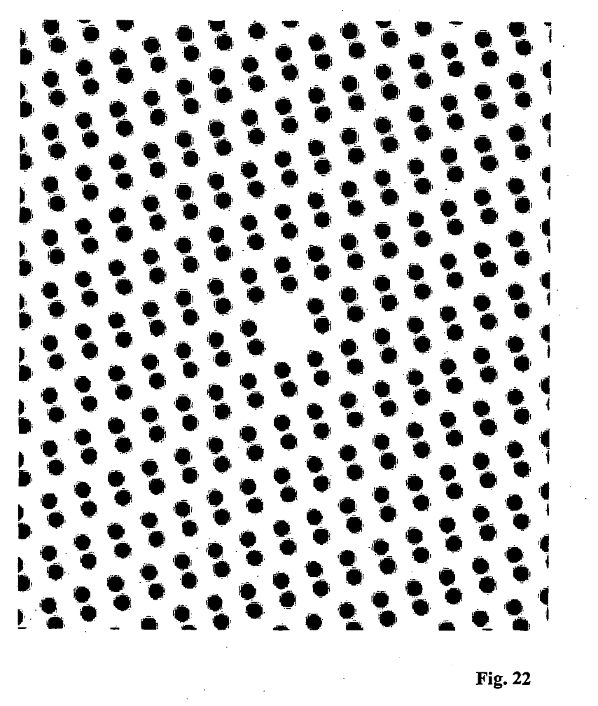

FIG. 22 shows an example of a structure that has been simulated to analyse an optical fibre as schematically shown in FIG. 21. The individual cladding elements are air holes and the cladding background material is pure silica. The core region is homogeneous and it comprises pure silica. The individual cladding elements have a largest dimension d of around 0.8 times a centre-to-centre distance Λ_{sub} between two nearest individual cladding elements within a sub-group. In preferred embodiments, d is in the range from 0.4Λ_{sub} to 0.99Λ_{sub}.

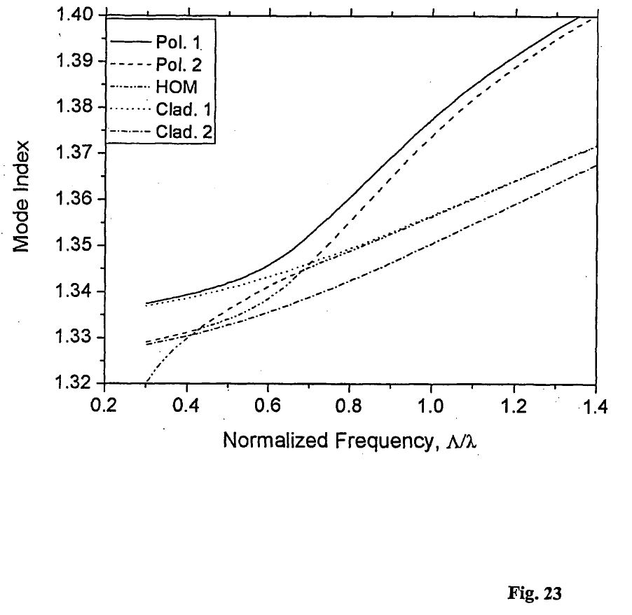

FIG. 23 shows the mode indices of the two polarisation states of the fundamental core mode (“Pol. 1 and 2”), of the two polarisation states of the fundamental cladding mode (“Clad. 1 and 2”), and of a higher order mode (“HOM”) for the optical fibre/structure in FIG. 22. FIG. 23 demonstrate that optical fibres with sub-groups of cladding elements, wherein the sub-groups have a substantially similar orientation may provide similar optical properties, an similar improved polarization properties, as was found for the fibre in FIG. 16.

1-27. (canceled)

28. An optical waveguide with a longitudinal direction and a cross-section perpendicular thereto for propagating optical radiation at a free-space wavelength λ, the optical waveguide comprising:
a core region (103),
a cladding region (100, 101, 102) surrounding the core region, and
a substantially one-dimensional (1D) periodic structure of structural elements with a period Λ;
wherein said structural elements comprises cross-sectionally extended continuous elements.

29. The waveguide according to claim 28 wherein, in the cross-section, said substantially one-dimensional (1D) periodic structure of cross-sectionally extended continuous elements (202, 1404) is arranged in at least a part of the core region

30. The waveguide according to claim 28 wherein, in the cross-section, said substantially one-dimensional (1D) periodic structure of cross-sectionally extended continuous elements is arranged in at least a part of the cladding region.

31. The waveguide according to claim 28 wherein, in the cross-section, a substantially one-dimensional (1D) periodic structure of cross-sectionally extended continuous elements is arranged in at least a part of the core region and another substantially one-dimensional (1D) periodic structure of cross-sectionally extended continuous elements is arranged in at least a part of the cladding region.

32. A waveguide according to claim 28 wherein at least one cross-sectionally extended continuous element exhibits a largest dimension larger than or equal to 3λ, preferably in the range including 3λ to 20λ.

33. A waveguide according to claim 28 wherein a major part of said cross-sectionally extended continuous elements exhibit a largest dimension larger than or equal to 3λ, preferably in the range including 3λ to 20λ.

34. A waveguide according to claim 28 wherein substantially all of said cross-sectionally extended continuous elements exhibit a largest dimension larger than or equal to 3λ, preferably in the range including 3λ to 20λ.

35. A waveguide according to claim 28 wherein at least one cross-sectionally extended continuous element exhibits a smallest dimension less than or equal to 1λ, preferably in the range including 0.3λ to 1.0λ.

36. A waveguide according to claim 28 wherein a major part of said cross-sectionally extended continuous elements exhibit a smallest dimension less than or equal to 1λ, preferably in the range including 0.3λ to 1.0λ.

37. A waveguide according to claim 28 wherein substantially all of said cross-sectionally extended continuous elements exhibit a smallest dimension less than or equal to 1λ, preferably in the range including 0.3λ to 1.0λ.

38. A waveguide according to claim 28 wherein said substantially 1D-periodic structure core elements has a period Λ_{core} smaller than or equal to 3λ, preferably smaller than 2λ, more preferably smaller than 1.5λ, most preferably smaller than 1.3λ, in particular smaller than λ, most particularly smaller than 0.5λ, and larger than 0.3λ.

39. A waveguide according to claim 28 wherein said cladding comprises cladding voids or holes that have a substantially circular cross-sectional shape.

40. A waveguide according to claim 39 wherein said cladding voids are arranged in a substantially two-dimensional periodic manner around said core region, wherein at least 3 periods of cladding voids are surrounding the core region, preferably more than 4 periods, in particular more than 5 periods.

41. A waveguide according to claim 39 wherein the cladding voids are arranged with a centre-to-centre distance Λ_{clad} between two of said cladding elements in the range of 3λ to 30λ.

42. A waveguide according to claim 28 wherein said core region has a cross-sectional dimension of 4λ or more.

43. A waveguide according to claim 28 wherein said structural elements are microstructured.

44. A waveguide according to claim 28 wherein said core region and said cladding region comprise silica and/or silica-based materials.

45. A waveguide according to claim 44 wherein said cross-sectionally extended elements (202) are of a high-index type of silica material, preferably Si doped with Er, Yb, or Nd, and additional dopants, preferably Al or Ge.

46. A waveguide according to claim 44 wherein the material (203) between said cross-sectionally extended elements (202) is undoped silica, or a low-index type of silica material, preferably silica doped with Er, Yb, or Nd, and optionally additional dopants, preferably F or B)

47. A waveguide according to claim 28 wherein said cladding region comprises an outer cladding comprising at least one ring of outer cladding voids or air holes, preferably two nearest outer cladding voids have a spacing equal to or less than 0.6 μm.

48. A waveguide according to claim 28 in form of an optical fibre.

49. An optical waveguide with a longitudinal direction and a cross-section perpendicular thereto for propagating optical radiation at a free-space wavelength λ, the optical waveguide comprising:
a core region, said core comprising a substantially one-dimensional (1D) periodic structure of structural core elements with a period Λ_{core}, and
a cladding region surrounding the core region, said cladding region comprising cladding elements arranged with a centre-to-centre distance Λ_{clad}.

50. The waveguide according to claim 49 wherein a centre-to-centre distance Λ_{clad} between two of said cladding elements is in the range of 3λ to 30λ.

51. The waveguide according to claim 49 wherein the core period Λ_{core} smaller than or equal to 3λ, preferably smaller than 2λ, more preferably smaller than 1.5λ, most preferably smaller than 1.3λ, in particular smaller than λ, most particularly smaller than 0.5λ, and larger than 0.3λ.

52. An optical waveguide with a longitudinal direction and a cross-section perpendicular thereto for propagating optical radiation at a free-space wavelength λ, the optical waveguide comprising:
a core region adapted to propagate optical radiation at a free-space wavelength λ, said core comprising a substantially one-dimensional (1D) periodic structure (103) of core elements (202, 204) with a period Λ_{core} in the range 0.3λ to 1.0λ, said core elements having a refractive index of n_{1,core}; and being spaced apart by a material (203, 205) of refractive index n_{2,core};
a cladding region surrounding the core region, said cladding region comprising cladding elements (100, 200) arranged in a background material (101, 201) in a periodic structure with a centre-to-centre distance Λ_{clad} larger than 3λ,
wherein the effective refractive index of the core is lower than the refractive index of the background material of the cladding region.

53. The waveguide according to claim 52 wherein the difference between n_{1,core} and n_{2,core} is larger than 1·10⁻³, preferably larger than 1·10⁻².

54. The waveguide according to claim 52 wherein the ratio Λ_{core}/Λ_{clad} is in the range including 0.02 to 0.5, preferably 0.06 to 0.2.

55. An optical waveguide with a longitudinal direction and a cross-section perpendicular thereto for propagating optical radiation at a free-space wavelength λ, the optical waveguide comprising:
a core region, said core comprising a substantially one-dimensional (1D) periodic structure of core elements with a period Λ_{core}, said periodic structure of core elements being arranged to exhibit a core shape with a two-fold rotational symmetry about the longitudinal direction, and
a cladding region surrounding the core region.

56. The waveguide according to claim 55 wherein said core shape has an extended shape with a smallest dimension y and a largest dimension x, said largest dimension x being larger than 1.2y.

57. The waveguide according to claim 55 wherein said core shape has an extended shape with a smallest dimension y and a largest dimension x, said smallest dimension x being smaller than 5y.

58. The waveguide according to claim 55 wherein said core shape has a substantially elliptical shape.

59. An optical waveguide with a longitudinal direction and a cross-section perpendicular thereto for propagating optical radiation at a free-space wavelength λ, the optical waveguide comprising:
a core region, said core comprising a substantially one-dimensional (1D) periodic structure of core elements with a period Λ_{core}, and
a cladding region surrounding the core region, said cladding region comprising at least one stress-inducing element.

60. The waveguide according to claim 59 wherein said cladding region comprising two stress-inducing elements, said stress-inducing elements being arranged on opposite positions of the core.

61. The waveguide according to claim 59 wherein said two stress-inducing elements are arranged orthogonally or parallel with respect to the direction of said 1D periodicity of the core.

62. An optical waveguide with a longitudinal direction and a cross-section perpendicular thereto for propagating optical radiation at a free-space wavelength λ, the optical waveguide comprising:
a core region,
a cladding region surrounding the core region, said cladding region comprising a substantially one-dimensional (1D) periodic structure of cladding elements with a period Λ_{clad}.

63. The waveguide according to claim 62 wherein said core exhibits a shape with two-fold rotation symmetry.

64. The waveguide according to claim 62 wherein said cladding comprises cladding elements arranged into sub-groups of at least 2 elements.

65. The waveguide according to claim 62 wherein said at least two sub-groups have similar orientation.

66. An optical waveguide with a longitudinal direction and a cross-section perpendicular thereto for propagating optical radiation at a free-space wavelength λ, the optical waveguide comprising:
a core region,
a cladding region surrounding the core region, said cladding region comprising a periodic structure of subgroups of at least two cladding elements with a period Λ_{clad,sub}.

67. The waveguide according to claim 66 wherein said at least two sub-group have similar orientation.

68. The waveguide according to claim 66 wherein said periodic structure of subgroups of at least two cladding elements is substantially one-dimensional (1D).

69. The waveguide according to claim 66 wherein said period Λ_{clad,sub} is in the range including 0.3λ to 3λ, preferably 0.5λ to 1.0λ.

70. The waveguide according to claim 66 wherein said at least two cladding elements have a substantially circular shape or a non-circular shape, preferably an elliptical shape.

71. An optical waveguide with a longitudinal direction and a cross-section perpendicular thereto for propagating optical radiation at a free-space wavelength λ, the optical waveguide comprising:
a core region, said core comprising a material having a refractive index n_{core} and exhibiting a shape of two-fold symmetry of rotation, said core providing different guiding of polarized light of different polarization states in the core, and
a cladding region surrounding the core region, said cladding region comprising a periodic structure of cladding elements with a period Λ_{clad}, said cladding elements being arranged in a background material with refractive index n_{clad,back},
wherein said core index n_{core} is selected to be less than said background index n_{clad,back} so that cut-off wavelengths for different polarisation states of the core do not coincide.

72. The waveguide according to claim 71, said waveguide being anti-guiding for light of λ<λ₁, single polarized for light of λ₁<λ<λ₂, and birefingent for light of λ₂<λ, λ₁ to λ₂ being cut-off wavelength for polarisation states of the fundamental mode.

73. A waveguide according to claim 28 wherein λ is in the range from 200 nm to 2.0 μm, preferably in a range of ultraviolet wavelengths, in a range of visible wavelength, or in a range of near-infrared wavelengths.

74. A waveguide according to claim 28 in form of an optical fibre.

75. An optical amplifier, the amplifier comprising an optical waveguide according to claim 28.

76. A tunable optical amplifier, the amplifier comprising an optical waveguide according to claim 28, and means for tuning the amplifying spectrum.

77. An optical laser, the laser comprising an optical waveguide according to claim 28.

78. A tuneable optical laser, the laser comprising an optical waveguide according to claim 28, and means for tuning the lasing wavelength.

79. A preform for preparing an optical waveguide as defined in claim 28, the preform being prepared by a method comprising: arranging precursor elements of said structural elements in a substantially 1D periodicity for making up the structural elements in the core, the cladding, or both.

80. A preform according to claim 79 wherein said precursor structural elements comprises precursor elements for cross-sectionally extended continuous elements.

81. A preform according to claim 80 wherein said precursor elements for cross-sectionally extended continuous elements comprise substantially plate-formed elements.

82. A method of producing an optical waveguide with a longitudinal direction and a cross-section perpendicular thereto for propagating optical radiation at a free-space wavelength λ, the optical waveguide having a core region (103), a cladding region (100, 101, 102) surrounding the core region, and a substantially one-dimensional (1D) periodic structure of structural elements with a period Λ said structural elements having cross-sectionally extended continuous elements, said method comprising preparing a preform as defined in claim 79, and drawing said preform into a waveguide, preferably an optical fibre.
